(19) United States
(12) Patent Application Publication
(10) Pub. No.: US 2026/0177943 A1
(43) Pub. Date: Jun. 25, 2026

(54) IMAGE FORMING APPARATUS

(71) Applicant: FUJIFILM Business Innovation Corp., Tokyo (JP)

(72) Inventor: Mitsuhiro MORI, Kanagawa (JP)

(73) Assignee: FUJIFILM Business Innovation Corp., Tokyo (JP)

(21) Appl. No.: 19/204,621

(22) Filed: May 12, 2025

(30) Foreign Application Priority Data
Dec. 24, 2024 (JP) 2024-227948

(51) Int. Cl. G03G 15/08

(52) U.S. Cl. CPC G03G 15/0808; G03G 15/0891; G03G 2215/0833

(57) ABSTRACT

An image forming apparatus includes an image holding body, a developing device that causes a developer to adhere to the image holding body, and a supply device that supplies the developer to the developing device and that includes an intersection direction flow path, which is a flow path that extends in an intersection direction and through which the developer passes, and a downward flow path, which is a flow path through which the developer moving through the intersection direction flow path passes and that extends downward so that the developer moving downward passes through the downward flow path, the intersection direction being a direction intersecting a perpendicular direction, in which a partition that partitions a space in the downward flow path and that partitions the space into a space positioned on an upstream side in a movement direction of the developer in the intersection direction flow path and a space positioned on a downstream side in the movement direction.

### CROSS-REFERENCE TO RELATED APPLICATIONS

This application is based on and claims priority under 35 USC 119 from Japanese Patent Application No. 2024-227948 filed Dec. 24, 2024.

### BACKGROUND

### (i) Technical Field

The present invention relates to an image forming apparatus.

### (ii) Related Art

JP2006-084487A discloses an image forming apparatus including an image carrier, a charging device, an exposure device, a developing device, a toner replenishment unit, a toner transport unit that connects a toner replenishment unit and the developing device to each other, a transfer device, and a cleaning device.

### SUMMARY

In an image forming apparatus, a supply device that supplies a developer to a developing device may be provided.

Here, there may also be a configuration in which a gas passes through the supply device. In addition, there may also be a case where the gas passes through a path along which the developer moves. In this case, it may be difficult for the gas to flow due to the developer in the path.

Aspects of non-limiting embodiments of the present disclosure relate to an image forming apparatus that makes a gas moving in a supply device flow smoothly in comparison with a configuration in which developer density in a cross section of a path along which a developer moves is less likely to be uneven.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an image holding body; a developing device that causes a developer to adhere to the image holding body; and a supply device that supplies the developer to the developing device and that includes an intersection direction flow path, which is a flow path that extends in an intersection direction and through which the developer passes, and a downward flow path, which is a flow path through which the developer moving through the intersection direction flow path passes and that extends downward so that the developer moving downward passes through the downward flow path, the intersection direction being a direction intersecting a perpendicular direction, in which a partition that partitions a space in the downward flow path and that partitions the space into a space positioned on an upstream side in a movement direction of the developer in the intersection direction flow path and a space positioned on a downstream side in the movement direction is provided in the downward flow path.

### BRIEF DESCRIPTION OF THE DRAWINGS

Exemplary embodiment(s) of the present invention will be described in detail based on the following figures, wherein:

FIG. 1 is a view showing an image forming apparatus;

FIG. 2 is a view of a developing device as seen from above;

FIG. 3 is a cross-sectional view of the developing device taken along line III-III in FIG. 2;

FIG. 4 is a cross-sectional view of the developing device taken along line IV-IV in FIG. 2;

FIG. 5 is a cross-sectional view of the developing device taken along line V-V in FIG. 2:

FIG. 6 is a cross-sectional view of the developing device taken along line VI-VI in FIG. 5;

FIG. 7 is a perspective view showing a supply device as seen from a rear surface side of the image forming apparatus;

FIG. 8 is a view showing a developer storage portion;

FIGS. 9A and 9B are views showing a filling portion and a gas flow path;

FIG. 10 is a perspective view showing the developer storage portion as seen from above;

FIG. 11 is an enlarged view of one end portion of the developer storage portion;

FIG. 12 is a view showing a state where an upper-side member is attached onto a lower-side container;

FIG. 13 is a cross-sectional view of the supply device taken along line XIII-XIII of FIG. 7;

FIG. 14 is a cross-sectional view of the supply device in a plane orthogonal to a longitudinal direction of a developer accommodation container;

FIG. 15 is a view showing the way in which a gas flows regarding a case where the supply device is seen from above;

FIG. 16 is a view showing a supply device according to a second exemplary embodiment;

FIG. 17 is a view showing a developer storage portion of the second exemplary embodiment as seen from above;

FIG. 18 is a cross-sectional view of the supply device taken along line XVIII-XVIII of FIG. 16;

FIG. 19 is a view showing another configuration example of the supply device of the first exemplary embodiment;

FIG. 20 shows the state of a central transport member and a partition;

FIG. 21 is a view showing another configuration example of the supply device;

FIG. 22 is a view showing another configuration example of the supply device;

FIG. 23 is a view showing another configuration example of guide portions;

FIG. 24 is a view showing another configuration example of the supply device;

FIG. 25 is a view showing another configuration example of the supply device;

FIG. 26 is a view showing another configuration example of the supply device;

FIG. 27 is a view showing another configuration example of the supply device;

FIG. 28 is a view showing another configuration example of the supply device;

FIG. 29 is a view showing another configuration example of the supply device;

FIG. 30 is a view showing another configuration example of the supply device;

FIG. 31 is a view showing another configuration example of the supply device; and

FIG. 32 is a view showing another configuration example of the supply device.

### DETAILED DESCRIPTION

An exemplary embodiment of the present invention will be described below with reference to the accompanying drawings.

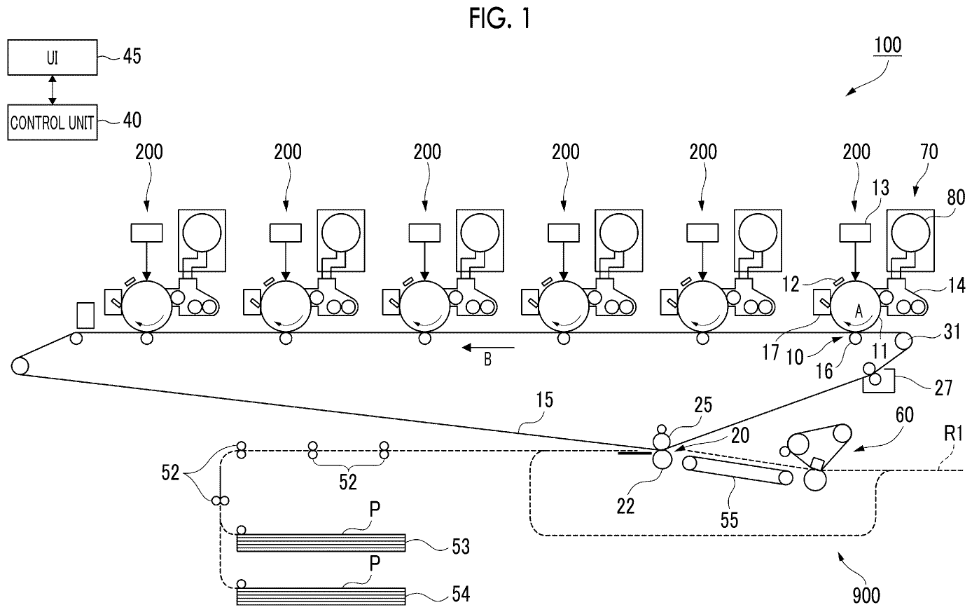

FIG. 1 is a view showing an image forming apparatus 100 according to the present exemplary embodiment. FIG. 1 shows the image forming apparatus 100 as seen from a front surface side of the image forming apparatus 100.

The image forming apparatus 100 is an intermediate transfer type image forming apparatus, which is called a tandem type image forming apparatus.

The image forming apparatus 100 is provided with a plurality of image forming units 200. Each of the image forming units 200 forms an image to be transferred to a paper sheet P, which is an example of a recording medium.

Each of the image forming units 200 includes a photoreceptor drum 11 which is an example of an image holding body.

Each of the image forming units 200 forms a toner image, which is an image to be transferred to the paper sheet P, on the photoreceptor drum 11 by using a developer containing toner. In other words, each of the image forming units 200 forms, on the photoreceptor drum 11 by using a powdery developer, a toner image.

A developer of the present exemplary embodiment is composed of a dry carrier and dry toner. Each of the image forming units 200 uses a carrier and toner to form a toner image on the photoreceptor drum 11.

Six image forming units 200 form toner images on the photoreceptor drums 11 by using different types of developers.

Four of the six image forming units 200 form toner images by using developers of basic colors. More specifically, the four image forming units 200 form toner images by using developers of yellow, magenta, cyan, and black.

The remaining two image forming units 200 form toner images by using developers of colors other than the basic colors.

The remaining two image forming units 200 form toner images by using developers of clear, white, gold, silver, or the like. Alternatively, the remaining two image forming units 200 form toner images by using, for example, developers of pink, green, orange, or the like.

Examples of the developers of colors other than the basic colors also include a developer containing magnetic toner. In addition, examples of the developers of colors other than the basic colors also include a developer containing conductive toner. In addition, examples of the developers of colors other than the basic colors also include a developer containing toner that emits light in a case where the toner is irradiated with light such as ultraviolet rays or infrared rays.

Note that in the present exemplary embodiment, a so-called two-component developer in which a carrier and toner are mixed with each other is used as a developer. In addition, as a developer, a so-called one-component developer composed of toner alone may also be used.

In addition, the image forming apparatus 100 is provided with an intermediate transfer belt 15. In addition, the image forming apparatus 100 is provided with primary transfer units 10. Toner images respectively formed by the image forming units 200 are transferred to the intermediate transfer belt 15 by the primary transfer units 10.

Furthermore, the image forming apparatus 100 is provided with a secondary transfer unit 20. The toner images transferred onto the intermediate transfer belt 15 are transferred to the paper sheet P at the secondary transfer unit 20.

In addition, the image forming apparatus 100 is provided with a fixing device 60 that fixes, onto the paper sheet P, the toner images transferred onto the paper sheet P.

Furthermore, the image forming apparatus 100 is provided with a control unit 40 that includes a CPU executing a program. The control unit 40 controls each unit in the image forming apparatus 100. In addition, the image forming apparatus 100 is provided with a user interface (UI) 45. The UI 45 is composed of a display panel or the like. The UI 45 receives an instruction from a user. The UI 45 displays information to the user.

Each of the image forming units 200 is provided with a developing device 14. In addition, each of the image forming units 200 is provided with a supply device 70.

The developing device 14 causes a developer to adhere onto the photoreceptor drum 11. The supply device 70 supplies a developer to the developing device 14.

In a case where the developing device 14 causes a developer to adhere onto the photoreceptor drum 11, an electrostatic latent image on the photoreceptor drum 11 is visualized by toner. The developing device 14 performs development with respect to the photoreceptor drum 11, which is an image holding body. Accordingly, an image formed of toner is formed on the photoreceptor drum 11.

The supply device 70 supplies a new developer to the developing device 14.

Developer accommodation containers 80 are mounted in the image forming apparatus 100. The supply device 70 transports a developer from the developer accommodation container 80 to the developing device 14. Accordingly, the developer is supplied to the developing device 14.

As described above, a developer is composed of a carrier and toner. The supply device 70 supplies a carrier and toner to the developing device 14 as a developer. Note that in the present exemplary embodiment, a carrier has a positive charging polarity, and toner has a negative charging polarity.

In each of the image forming units 200, the photoreceptor drum 11 which is an example of an image holding body rotates in a direction along an arrow A.

In addition, each of the image forming units 200 is provided with a charger 12. Furthermore, each of the image forming units 200 is provided with an exposure device 13.

The charger 12 charges the photoreceptor drum 11. The exposure device 13 forms an electrostatic latent image on the photoreceptor drum 11.

The exposure device 13 includes a light source such as an LED. The exposure device 13 irradiates the photoreceptor drum 11 with light to form an electrostatic latent image on the photoreceptor drum 11.

In addition, each of the image forming units 200 is provided with a primary transfer roll 16. The primary transfer roll 16 is provided at the primary transfer unit 10. The primary transfer roll 16 is used to transfer a toner image from the photoreceptor drum 11 to the intermediate transfer belt 15.

In addition, each of the image forming units 200 is provided with a drum cleaner 17 that removes a developer remaining on the photoreceptor drum 11.

A drive roll 31 causes the intermediate transfer belt 15 to circulate at a predetermined speed in a direction along an arrow B which is shown in FIG. 1. The drive roll 31 is driven by a motor (not shown) and rotates in a counterclockwise direction in the drawing.

The primary transfer units 10 are configured to include the primary transfer rolls 16 that are disposed to face the photoreceptor drums 11 with the intermediate transfer belt 15 interposed therebetween. Toner images on the photoreceptor drums 11 move to the intermediate transfer belt 15 at the primary transfer units 10. Accordingly, the toner images are formed on the intermediate transfer belt 15.

The secondary transfer unit 20 which is an example of a transfer unit is provided with a secondary transfer roll 22 that is disposed on an outer surface side of the intermediate transfer belt 15. In addition, the secondary transfer unit 20 is provided with a backup roll 25 that is disposed on an inner surface side of the intermediate transfer belt 15.

At the secondary transfer unit 20, toner images that are formed on the intermediate transfer belt 15 are transferred to the paper sheet P transported to the secondary transfer unit 20.

Furthermore, an inversion mechanism 900 that inverts the paper sheet P is provided.

The inversion mechanism 900 inverts the paper sheet P with one surface on which the toner images have been transferred at the secondary transfer unit 20 upside down. Then, the inversion mechanism 900 supplies, to the secondary transfer unit 20 again, the paper sheet P inverted upside down.

Accordingly, the toner images are formed on both surfaces of the paper sheet P.

The flow of processing performed in the image forming apparatus 100 will be described.

The image forming apparatus 100 receives image data output from, for example, an image reading apparatus (not shown) or a computer. Then, the image data is subjected to image processing in the image forming apparatus 100. Accordingly, image data corresponding to each of the plurality of image forming units 200 is generated.

Specifically, image data corresponding to each of four basic colors which are yellow, magenta, cyan, and black is generated. In addition, image data corresponding to a color other than the basic colors is generated.

The generated image data is output to the exposure devices 13 provided at the image forming units 200.

In accordance with the image data input to the exposure devices 13, the exposure devices 13 irradiate the photoreceptor drums 11 with light emitted from light sources.

Before the exposure devices 13 irradiate the photoreceptor drums 11 with the light, respective surfaces of the photoreceptor drums 11 are charged by the chargers 12. After the surfaces are charged, the exposure devices 13 irradiate the surfaces with the light. Accordingly, electrostatic latent images are formed on the surfaces of the photoreceptor drums 11.

Next, development is performed by the developing devices 14 so that toner contained in developers adheres onto the photoreceptor drums 11. Accordingly, toner images are formed on the photoreceptor drums 11. The toner images are transferred onto the intermediate transfer belt 15 at the primary transfer units 10.

After the toner images are transferred onto the intermediate transfer belt 15, the toner images are moved to the secondary transfer unit 20 as the intermediate transfer belt 15 moves.

At this time, the paper sheet P from a first paper sheet accommodation portion 53 or a second paper sheet accommodation portion 54 is transported to the secondary transfer unit 20 by transport rolls 52 or the like. Then, the toner images on the intermediate transfer belt 15 are electrostatically transferred onto the paper sheet P in a collective manner at the secondary transfer unit 20.

Thereafter, the paper sheet P onto which the toner images have been transferred is peeled from the intermediate transfer belt 15 and is transported to a transport belt 55. The transport belt 55 transports the paper sheet P to the fixing device 60.

The paper sheet P transported to the fixing device 60 is heated and pressed at the fixing device 60. Accordingly, the toner images on the paper sheet P are fixed to the paper sheet P. Then, the paper sheet P is discharged from the image forming apparatus 100.

The developing devices 14 will be described.

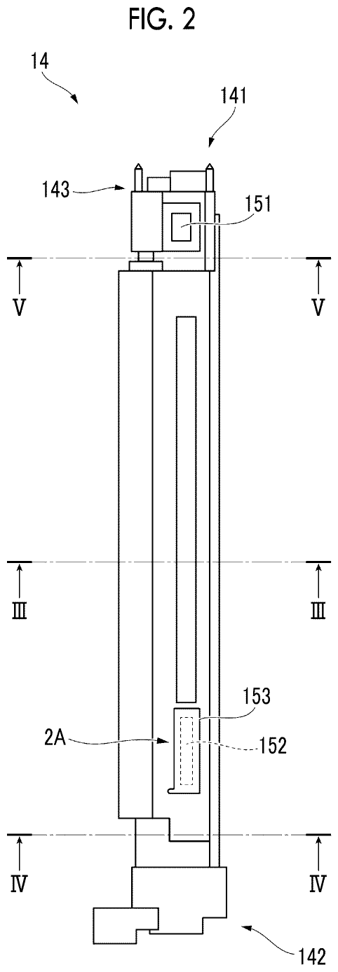

FIG. 2 is a view of the developing device 14 as seen from above.

In a case where the developing device 14 is installed in the image forming apparatus 100, the developing device 14 is disposed along a depth direction of the image forming apparatus 100. The developing device 14 includes one end portion 141 and the other end portion 142, of which the positions are different from each other in a longitudinal direction.

In a case where the developing device 14 is installed in the image forming apparatus 100, the one end portion 141 is positioned on a rear surface side of the image forming apparatus 100. In addition, the other end portion 142 is positioned on a front surface side of the image forming apparatus 100.

A drive force receiving portion 143 that receives a drive force is provided at the one end portion 141 of the developing device 14. A drive force from a drive source (not shown), such as a motor, is transmitted to the drive force receiving portion 143, the drive source being provided on a body side of the image forming apparatus 100.

The drive force receiving portion 143 is linked to a transport member or the like (which will be described later) provided inside the developing device 14. The transport member or the like is rotated as the drive force from the drive source is transmitted to the drive force receiving portion 143.

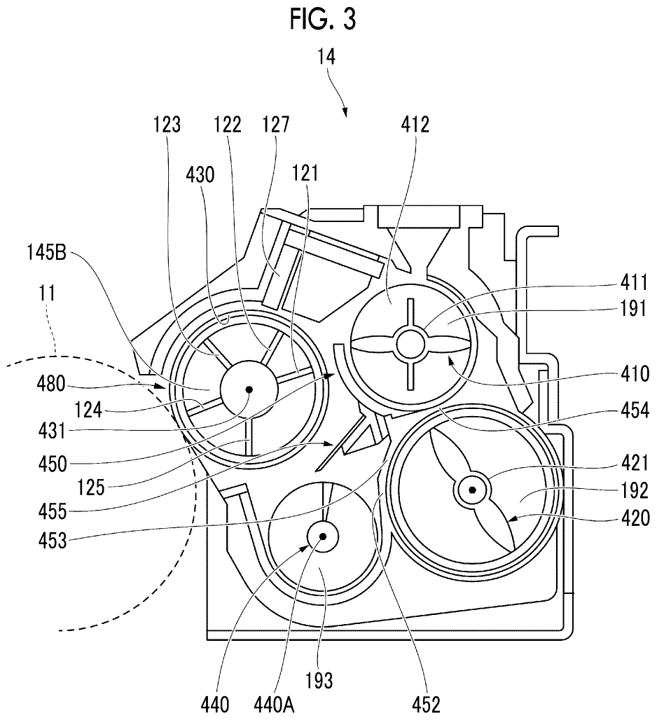

FIG. 3 is a cross-sectional view of the developing device 14 taken along line III-III in FIG. 2. FIG. 3 shows the state of a cross section of a central portion of the developing device 14 in the longitudinal direction.

The developing device 14 is provided with a one-direction movement path 191 through which a developer passes in a case where the developer is to be moved in one direction.

In addition, the developing device 14 is provided with an opposite-direction movement path 192 through which the developer passes in a case where the developer is to be moved in a direction opposite to the one direction. The opposite-direction movement path 192 is disposed below the one-direction movement path 191.

In the one-direction movement path 191, the developer moves in a direction perpendicular to the paper surface of FIG. 3 and in a direction to the rear side of the paper surface. In addition, in the opposite-direction movement path 192, the developer moves in a direction perpendicular to the paper surface of FIG. 3 and in a direction to the front side of the paper surface.

The one-direction movement path 191 is provided with a one-direction transport member 410 that transports the developer.

The one-direction transport member 410 rotates about a rotary shaft 411 extending along the one-direction movement path 191. The developer moves in the direction to the rear side of the paper surface of FIG. 3 as the one-direction transport member 410 rotates.

The opposite-direction movement path 192 is provided with an opposite-direction transport member 420 that transports the developer. The opposite-direction transport member 420 is disposed below the one-direction transport member 410.

The opposite-direction transport member 420 rotates around a rotary shaft 421 that extends along the opposite-direction movement path 192. Accordingly, the developer transported by the opposite-direction transport member 420 moves in the direction to the rear side of the paper surface of FIG. 3.

The opposite-direction transport member 420 transports the developer in the direction opposite to the one direction.

Furthermore, a rotating body 430 is provided to the left of the one-direction transport member 410. The rotating body 430 is used to supply a developer to the photoreceptor drum 11 which is an example of an image holding body.

Furthermore, the developing device 14 is provided with a facing opening 480. The facing opening 480 is disposed at a position facing the photoreceptor drum 11.

The rotating body 430 is installed in the facing opening 480. In the present exemplary embodiment, the rotating body 430 is partially exposed through the facing opening 480.

The rotating body 430 supplies, to the photoreceptor drum 11, a developer supplied to the rotating body 430 from the one-direction transport member 410. The developer is supplied from the one-direction transport member 410 to the rotating body 430 and the rotating body 430 supplies the developer to the photoreceptor drum 11.

The rotating body 430 is composed of a cylindrical body. The rotating body 430 is formed of, for example, a metal such as SUS.

The rotating body 430 rotates in a counterclockwise direction in the drawing around an axis 431. The rotating body 430 moves, to the photoreceptor drum 11, a developer that is supplied from the one-direction transport member 410 and that adheres to an outer peripheral surface of the rotating body 430.

Accordingly, the developer is supplied to the photoreceptor drum 11, and toner contained in the developer adheres to a surface of the photoreceptor drum 11.

Furthermore, a first movement restriction portion 450 is provided between the rotating body 430 and the one-direction transport member 410. The first movement restriction portion 450 restricts movement of a portion of a developer caused to move toward the rotating body 430 from the one-direction transport member 410.

In the present exemplary embodiment, a portion of a developer on the one-direction movement path 191 moves over the first movement restriction portion 450. In the present exemplary embodiment, the developer that has moved over the first movement restriction portion 450 is supplied to the rotating body 430.

Furthermore, a lower-side transport member 440 is provided below the rotating body 430.

The lower-side transport member 440 is a rotating member that rotates around an axis 440A extending along the above-described one direction. The lower-side transport member 440 is disposed closer to the photoreceptor drum 11 side than the opposite-direction transport member 420 is.

The lower-side transport member 440 transports a developer separated from the rotating body 430 in the direction perpendicular to the paper surface of FIG. 3 and in the direction to the rear side of the paper surface.

The lower-side transport member 440 transports the developer separated from the rotating body 430 in the above-described one direction. Accordingly, the developer is supplied to one end portion side of the opposite-direction transport member 420 (details will be described later).

Furthermore, a second movement restriction portion 452 is provided between the lower-side transport member 440 and the opposite-direction transport member 420. The second movement restriction portion 452 restricts movement of a developer moving toward the lower-side transport member 440 from the opposite-direction transport member 420.

In addition, a third movement restriction portion 453 is provided between the rotating body 430 and the opposite-direction transport member 420. The third movement restriction portion 453 restricts movement of a developer moving toward the rotating body 430 from the opposite-direction transport member 420.

Furthermore, a fourth movement restriction portion 454 is provided between the one-direction transport member 410 and the opposite-direction transport member 420.

The fourth movement restriction portion 454 restricts movement of a developer moving from the one-direction transport member 410 to the opposite-direction transport member 420. In addition, the fourth movement restriction portion 454 restricts movement of a developer moving from the opposite-direction transport member 420 to the one-direction transport member 410.

Furthermore, a fifth movement restriction portion 455 is provided between the rotating body 430 and the lower-side transport member 440. The fifth movement restriction portion 455 restricts movement of a developer moving toward the rotating body 430 from the lower-side transport member 440.

A magnet roll 145B is provided inside the rotating body 430.

The magnet roll 145B is provided with five magnetic poles 121 to 125 arranged in a circumferential direction of the magnet roll 145B.

The magnetic pole 121 is a pickup pole and attracts a developer supplied from the one-direction movement path 191. Accordingly, the developer adheres to a surface of the rotating body 430.

The magnetic poles 122 to 124 have a role as transport poles. The magnetic poles 122 to 124 move the developer on the surface of the rotating body 430 to a downstream side in a rotation direction of the rotating body 430.

In the rotation direction of the rotating body 430, a facing restriction portion 127 is provided downstream of the magnetic pole 122 and upstream of the magnetic pole 123. In addition, the facing restriction portion 127 is disposed at a position facing the outer peripheral surface of the rotating body 430.

The facing restriction portion 127 is disposed with a gap provided between the facing restriction portion 127 and the rotating body 430. The facing restriction portion 127 restricts movement of a portion of a developer adhering to the surface of the rotating body 430. Accordingly, the thickness of the developer adhering to the surface of the rotating body 430 becomes a predetermined thickness.

The developer on the surface of the rotating body 430 moves to the downstream side in a rotation direction of the rotating body 430. Thereafter, the developer moves to the surface of the photoreceptor drum 11 and toner contained in the developer adheres to the photoreceptor drum 11.

Accordingly, development is performed, and a toner image is formed on the surface of the photoreceptor drum 11.

The toner image is temporarily held by the photoreceptor drum 11. Then, the toner image is moved to the primary transfer unit 10 (refer to FIG. 1) with the photoreceptor drum 11 rotating. Then, the toner image is transferred to the intermediate transfer belt 15.

The magnetic pole 125 shown in FIG. 3 has a role as a pick-off pole. The magnetic pole 125 forms a repulsive magnetic field, and causes the developer adhering to the surface of the rotating body 430 to be separated from the rotating body 430.

The magnetic pole 125 causes the developer that is not transferred to the photoreceptor drum 11 to be separated from the rotating body 430.

The developer separated from the rotating body 430 moves downward and reaches a lower-side movement path 193.

The developer that has reached the lower-side movement path 193 is moved toward the one end portion 141 side of the developing device 14, which is shown in FIG. 2, by the lower-side transport member 440. Then, the developer is moved to the opposite-direction movement path 192. Details of the movement of the developer to the opposite-direction movement path 192 will be described later.

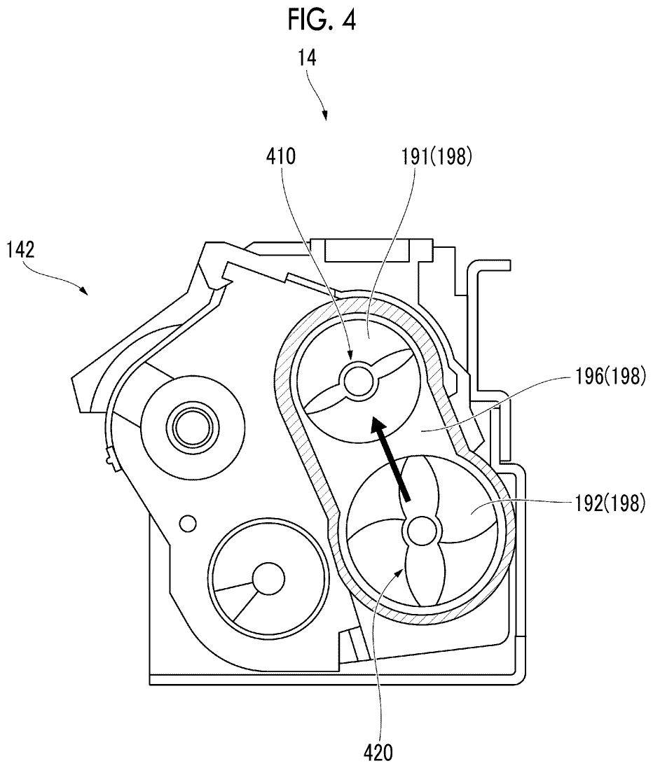

FIG. 4 is a cross-sectional view of the developing device 14 taken along line IV-IV in FIG. 2.

FIG. 4 shows the state of a cross section of the other end portion 142 of the developing device 14.

An upward movement path 196 disposed along a vertical direction is provided at the other end portion 142 of the developing device 14. A developer that has moved through the opposite-direction movement path 192 moves toward the one-direction movement path 191 through the upward movement path 196.

In the present exemplary embodiment, a developer accumulates at an end portion of the opposite-direction movement path 192 that is positioned on a downstream side in a movement direction of the developer. In addition, in the present exemplary embodiment, the developer accumulating at the end portion is pressed by a developer sequentially transported from an upstream side. Accordingly, the developer accumulating at the end portion moves upward through the upward movement path 196.

As a result, the developer in the opposite-direction movement path 192 moves toward the one-direction movement path 191 through the upward movement path 196.

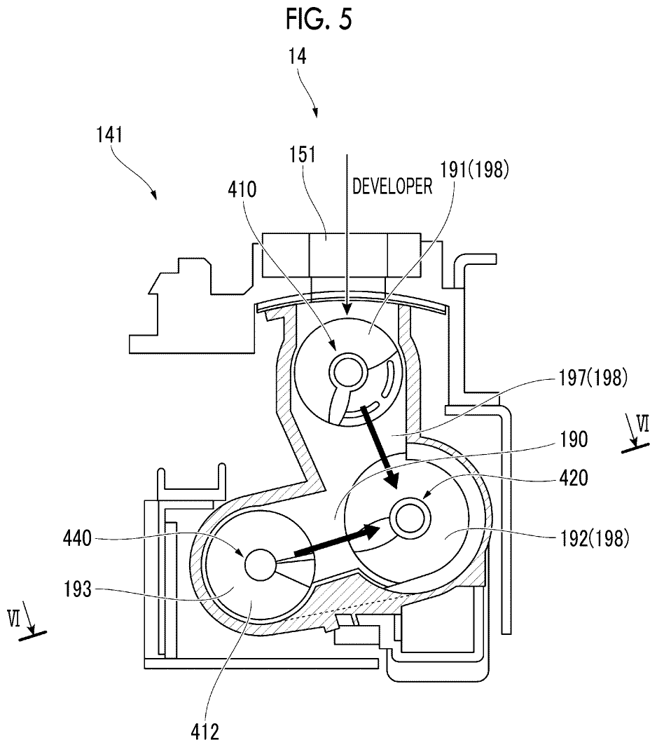

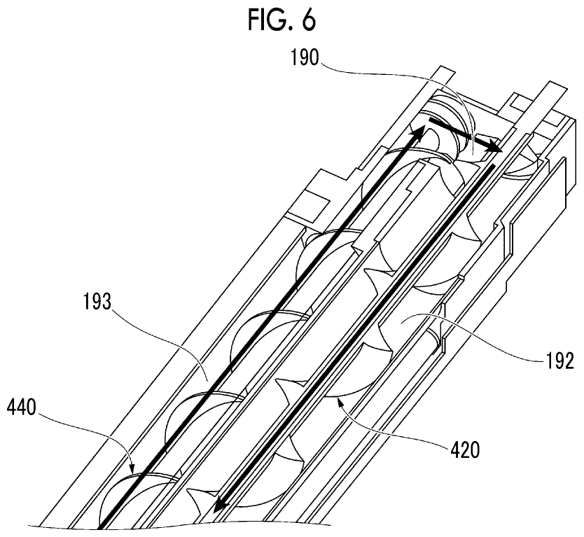

FIG. 5 is a cross-sectional view of the developing device 14 taken along line V-V in FIG. 2. FIG. 6 is a cross-sectional view of the developing device 14 taken along line VI-VI in FIG. 5.

FIG. 5 shows the state of a cross section of the one end portion 141 of the developing device 14.

As shown in FIG. 5, a downward movement path 197 disposed along the vertical direction is provided at the one end portion 141 of the developing device 14.

A developer that has moved through the one-direction movement path 191 moves toward the opposite-direction movement path 192 through the downward movement path 197.

Furthermore, in the present exemplary embodiment, as shown in FIGS. 5 and 6, a connection path 190 is provided. The connection path 190 extends in a lateral direction and connects the lower-side movement path 193 and the opposite-direction movement path 192 to each other.

In the present exemplary embodiment, a developer is moved along the lower-side movement path 193 by the lower-side transport member 440. Then, the developer moved along the lower-side movement path 193 moves to the opposite-direction movement path 192 through the connection path 190.

In the present exemplary embodiment, a developer accumulates at an end portion of the lower-side movement path 193 that is positioned on a downstream side in a movement direction of the developer.

In addition, in the present exemplary embodiment, the developer accumulating at the end portion is pressed by a developer sequentially transported from an upstream side. Accordingly, the developer accumulating at the end portion moves to the opposite-direction movement path 192 through the connection path 190.

In the present exemplary embodiment, a developer moves along the one-direction movement path 191 and the opposite-direction movement path 192 shown in FIG. 3. Accordingly, in the present exemplary embodiment, a developer circulates.

In the present exemplary embodiment, a portion of the developer moving through the one-direction movement path 191 is supplied to the rotating body 430. The developer is supplied to the photoreceptor drum 11 via the rotating body 430.

A developer that remains on the surface of the rotating body 430 without being supplied to the photoreceptor drum 11 is separated from the rotating body 430 and moves to the lower-side movement path 193. Then, the developer moves to the opposite-direction movement path 192 through the lower-side movement path 193.

Furthermore, in the present exemplary embodiment, as shown in FIG. 2, the developing device 14 is provided with a first reception port 151 for reception of a developer. The developing device 14 receives a developer sent from the supply device 70, through the first reception port 151.

As shown in FIG. 5, the developer sent from the supply device 70 enters the developing device 14 through the first reception port 151.

In addition, in the present exemplary embodiment, a second reception port 152 is provided at a position represented by a reference numeral “2A” in FIG. 2. The second reception port 152 is blocked by a blocking member 153.

In the present exemplary embodiment, a user can manually supply a new developer to the developing device 14 by using a jig (not shown).

In a case where a new developer is to be manually supplied by the user, the user peels off the blocking member 153 first. Then, the user supplies the developer to the developing device 14 through the second reception port 152 that becomes able to be seen in a case where the blocking member 153 is peeled off.

Furthermore, as shown in FIG. 3, the developing device 14 of the present exemplary embodiment is provided with the facing opening 480 in which the rotating body 430 is installed.

In the present exemplary embodiment, the first reception port 151, the second reception port 152, and the facing opening 480 are provided as openings.

In the present exemplary embodiment, the developing device 14 is not provided with openings other than the first reception port 151, the second reception port 152, and the facing opening 480.

The developing device 14 of the present exemplary embodiment is provided with connection openings that are openings through which the inside of the developing device 14 and the outside of the developing device 14 are connected to each other. In the present exemplary embodiment, the developing device 14 is not provided with connection openings other than the first reception port 151, the second reception port 152, and the facing opening 480.

In the present exemplary embodiment, the internal pressure of the developing device 14 is released not through the connection openings provided at the developing device 14 but through an opening provided at the supply device 70.

In the present exemplary embodiment, a developer adhering to the surface of the rotating body 430 returns to the inside of the developing device 14 without being transferred to the photoreceptor drum 11. In this case, air outside the developing device 14 is taken into the developing device 14. Accordingly, the internal pressure of the developing device 14 increases.

As the internal pressure of the developing device 14 increases, a gas is caused to move from the inside of the developing device 14 to the outside of the developing device 14. In the present exemplary embodiment, a gas that is caused to move from the inside of the developing device 14 to the outside of the developing device 14 moves toward the supply device 70 shown in FIG. 1.

Then, the gas is discharged to the outside of the supply device 70 through the opening provided at the supply device 70. Examples of the gas include air.

In a case where a gas is discharged only through the connection openings provided at the developing device 14, a gas is likely to be discharged in a state where the pressure thereof is high.

However, in the present exemplary embodiment, a gas is discharged through the opening provided at the supply device 70 that is separated from the developing device 14. In this case, a gas is discharged through the opening in a state where the pressure thereof is reduced.

In a case where a gas is discharged in a state where the pressure thereof is reduced, the amount of a developer moving to the outside through the opening provided at the supply device 70 is made small. In this case, a filter installed at the opening is less likely to be contaminated, and thus the life of the filter is extended.

Note that providing a connection opening at the developing device 14 is not to be ruled out. A configuration in which the developing device 14 is provided with a connection opening and the supply device 70 is further provided with an opening may also be adopted.

In this case, a gas inside the developing device 14 is discharged to the outside of the developing device 14 through the connection opening. In addition, in this case, a gas inside the developing device 14 is discharged to the outside of the developing device 14 through the opening provided at the supply device 70.

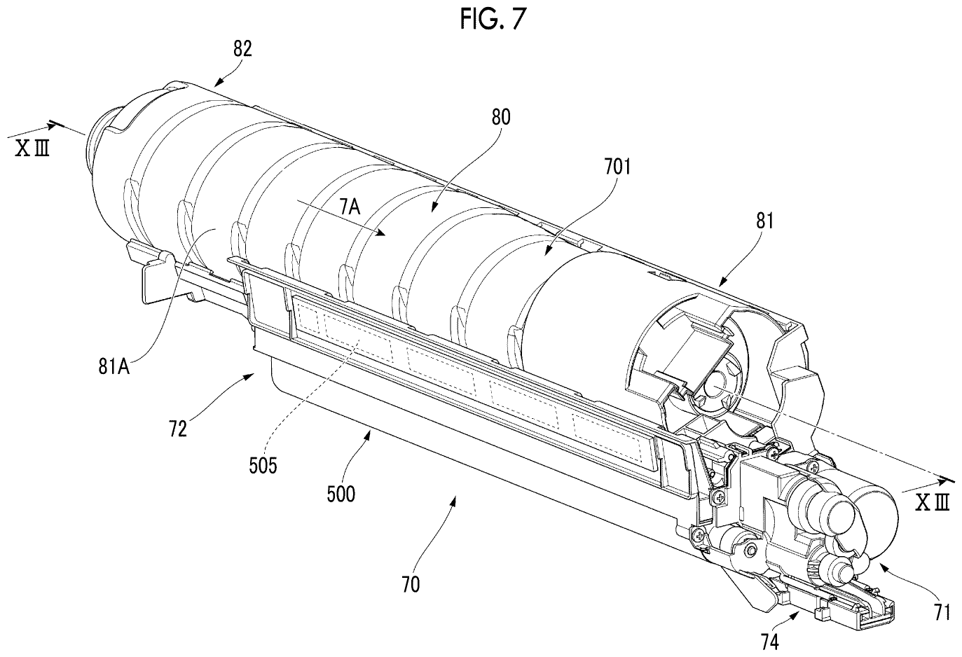

FIG. 7 is a perspective view showing the supply device 70 as seen from the rear surface side of the image forming apparatus 100. FIG. 7 shows a state after attachment of the developer accommodation container 80.

The developer accommodation container 80 accommodates, for example, an unused developer. In the present exemplary embodiment, the developer accommodation container 80 is attachable to and detachable from the image forming apparatus 100 (refer to FIG. 1). The developer accommodation container 80 is mounted on a mounting target portion 701 of the supply device 70.

In a case where the developer accommodation container 80 is to be mounted in the image forming apparatus 100, the developer accommodation container 80 is moved in a direction represented by an arrow 7A in FIG. 7.

The developer accommodation container 80 is formed in a tubular shape. Specifically, the developer accommodation container 80 is formed in a cylindrical shape. Note that the shape of the developer accommodation container 80 is not limited to a cylindrical shape. The developer accommodation container 80 may be formed in a columnar shape.

In a case where the developer accommodation container 80 is mounted in the image forming apparatus 100, the supply device 70 is positioned below the developer accommodation container 80.

In the present exemplary embodiment, a developer from the developer accommodation container 80 is supplied to the developing device 14 by the supply device 70. Note that in FIG. 7, the developing device 14 is not shown.

The developer accommodation container 80 includes one end portion 81 that is positioned at the head in a case where the developer accommodation container 80 is accommodated into the image forming apparatus 100. In addition, the developer accommodation container 80 includes the other end portion 82 positioned on a side opposite to the one end portion 81.

An outlet portion for a developer is provided at a lower portion of the one end portion 81 of the developer accommodation container 80. A developer in the developer accommodation container 80 moves, through the outlet portion, to the supply device 70 positioned below the developer accommodation container 80.

The supply device 70 includes one end portion 71 and the other end portion 72.

The one end portion 71 of the supply device 70 is positioned on the rear surface side of the image forming apparatus 100. The other end portion 72 of the supply device 70 is positioned on the front surface side of the image forming apparatus 100.

A reception port through which a developer from the developer accommodation container 80 is received is provided on the one end portion 71 side of the supply device 70.

The developer accommodation container 80 has a function of sending a developer in the developer accommodation container 80 to the outside of the developer accommodation container 80. A member for the sending of the developer to the outside of the developer accommodation container 80 is provided inside the developer accommodation container 80.

Furthermore, the supply device 70 is provided with a developer storage portion 500 storing a developer that enters the supply device 70 through the reception port.

A developer supplied from the developer accommodation container 80 to the supply device 70 is temporarily accommodated in the developer storage portion 500.

The developer is temporarily stored in the developer storage portion 500.

The developer is discharged through a discharge port 74 provided at the one end portion 71 of the supply device 70 after moving through the developer storage portion 500.

The supply device 70 is provided with the discharge port 74 used to discharge the developer received through the reception port. The developer discharged through the discharge port 74 is supplied to the developing device 14 positioned below the discharge port 74. Note that in FIG. 7, the developing device 14 is not shown.

In the present exemplary embodiment, the first reception port 151 provided at the developing device 14 shown in FIG. 2 is disposed directly below the discharge port 74 of the supply device 70.

The developer discharged through the discharge port 74 moves into the developing device 14 through the first reception port 151. In this manner, a developer is supplied from the supply device 70 to the developing device 14.

A developer is temporarily stored in the developer storage portion 500.

Accordingly, even in a case where the developer accommodation container 80 is removed, the developer can be supplied from the supply device 70 to the developing device 14. As the developer accommodation container 80 becomes empty, the developer accommodation container 80 is removed.

In the present exemplary embodiment, the developer in the developer storage portion 500 is supplied to the developing device 14 even in a case where the developer accommodation container 80 is removed.

Accordingly, even in a case where the developer accommodation container 80 is removed, the developer can be supplied from the supply device 70 to the developing device 14. In this case, immediate stoppage of an image forming operation that occurs immediately after the removal of the developer accommodation container 80 can be avoided. In this case, image formation can be continued until a new developer accommodation container 80 is mounted.

The supply device 70 is provided with openings 505 through which the inside of the supply device 70 and the outside of the supply device 70 communicate with each other. The openings 505 are positioned at positions facing an outer peripheral surface 81A of the developer accommodation container 80 mounted to the mounting target portion 701.

The expression “being positioned at a position facing the outer peripheral surface 81A” means a state where the openings 505 are positioned at a space positioned at a position facing the outer peripheral surface 81A.

Even a case where a member is present between the openings 505 and the outer peripheral surface 81A corresponds to “being positioned at a position facing the outer peripheral surface 81A”. Furthermore, even a case where the openings 505 face a side opposite to a side on which the outer peripheral surface 81A is positioned corresponds to “being positioned at a position facing the outer peripheral surface 81A”.

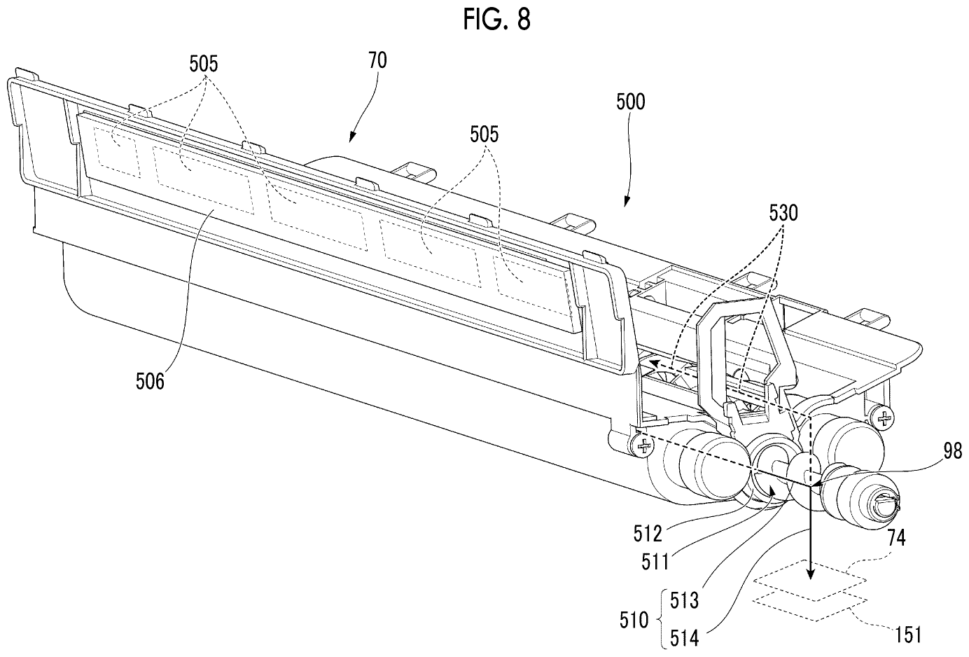

FIG. 8 is a view showing the developer storage portion 500.

The developer storage portion 500 is provided with a developer flow path 510 through which a developer moving toward the developing device 14 passes. The developer flow path 510 is provided to extend from the inside of the developer storage portion 500 to the outside of the developer storage portion 500.

A filling portion 511 is present on the developer flow path 510. At the filling portion 511, the developer flow path 510 is filled with a developer over the entire cross section of the developer flow path 510.

In the present specification, a “cross section” of the developer flow path 510 refers to a cross section of the developer flow path 510 in a plane orthogonal to a direction in which the developer flow path 510 extends.

A tubular portion 512 is provided around the filling portion 511. In the present exemplary embodiment, the inside of the tubular portion 512 is the filling portion 511.

In a cross section orthogonal to an axial direction of the tubular portion 512, the inside of the tubular portion 512 is entirely filled with a developer.

Accordingly, in the cross section orthogonal to the axial direction of the tubular portion 512, developer density is high.

Accordingly, in the present exemplary embodiment, the filling portion 511 in a state of being filled with a developer is formed inside the tubular portion 512.

In a configuration in which the filling portion 511 is formed, the amount of a developer supplied from the supply device 70 to the developing device 14 per unit time is stabilized.

In a case where the filling portion 511 is not present, developer density regarding a developer moving toward the developing device 14 is likely to be uneven. In this case, the amount of the developer supplied from the supply device 70 to the developing device 14 per unit time is likely to vary.

At a position downstream of the filling portion 511 in a transport direction of a developer, a direction in which the developer flow path 510 extends changes to a downward direction.

The developer flow path 510 is provided with a lateral flow path 513 extending in a lateral direction and a vertical flow path 514 extending in the vertical direction.

A developer passing through the filling portion 511 moves in a direction away from the filling portion 511 through the lateral flow path 513. Thereafter, the developer moves downward through the vertical flow path 514. The developer falls down in the vertical flow path 514.

The discharge port 74 of the supply device 70 and the first reception port 151 of the developing device 14 are provided below the vertical flow path 514. A developer flowing downward through the vertical flow path 514 is supplied to the developing device 14.

Furthermore, a gas flow path 530, which is a flow path through which a gas flowing from the developing device 14 to the supply device 70 passes, is provided. The gas flow path 530 is provided separately from the developer flow path 510.

In the present exemplary embodiment, as described above, a gas flows toward the supply device 70 from the developing device 14 as the internal pressure of the developing device 14 increases.

The gas flowing from the developing device 14 to the supply device 70 enters the supply device 70 through the discharge port 74 of the supply device 70.

Thereafter, the gas passes through the vertical flow path 514 and flows upward. Next, the gas enters the gas flow path 530 provided to branch off from the developer flow path 510.

The gas entering the gas flow path 530 moves toward the openings 505 provided at the supply device 70, and is discharged through the openings 505. A filter 506 is installed for the openings 505. In FIG. 8, the openings 505 are provided behind the filter 506.

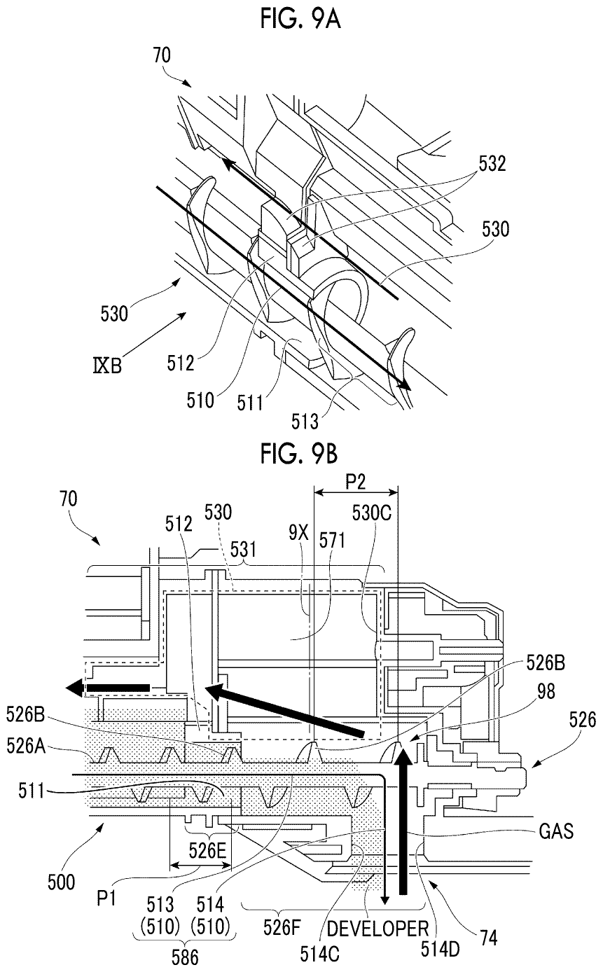

FIGS. 9A and 9B are views showing the filling portion 511 and the gas flow path 530.

FIG. 9A is a perspective view of the filling portion 511 and the gas flow path 530. FIG. 9B is a view showing the filling portion 511 and the gas flow path 530 as seen in a direction represented by an arrow IXB in FIG. 9A.

In the present exemplary embodiment, as described above and as shown in FIG. 9A, the developer flow path 510 is provided. The developer flow path 510 extends from the inside of the developer storage portion 500 to the outside of the developer storage portion 500.

The filling portion 511 is present on the developer flow path 510 and inside the tubular portion 512. Furthermore, the gas flow path 530 is provided above the tubular portion 512 in the drawing. The gas flow path 530 is provided above the filling portion 511.

As shown in FIG. 8, the gas flow path 530 is provided to branch off from the developer flow path 510.

A node portion 98, which is an example of a branching position where the gas flow path 530 branches off from the developer flow path 510, is present. The node portion 98 is positioned downstream of the filling portion 511 in the transport direction of the developer.

At a position downstream of the filling portion 511 in the transport direction of the developer, the gas flow path 530 branches off from the developer flow path 510.

The gas flow path 530 branches off from the developer flow path 510 and then passes through a space above the filling portion 511 as shown in FIG. 9A.

A gas passing through the gas flow path 530 passes through the space above the filling portion 511. The gas passing through the gas flow path 530 moves toward an upstream side in a movement direction of the developer through a position other than the filling portion 511.

In the filling portion 511, developer density is high and thus it is difficult for a gas to pass through the filling portion 511. Therefore, in the present exemplary embodiment, the gas flow path 530 for passage of a gas is provided at the position other than the filling portion 511.

As shown in FIG. 8, the gas flow path 530 extends toward a side where the tubular portion 512 is provided from the node portion 98. The gas flow path 530 further extends, through a space above the tubular portion 512, toward the upstream side in the movement direction of the developer.

In addition, as will be described later, the gas flow path 530 is connected to a space inside the supply device 70 again. In other words, the gas flow path 530 leads to the space inside the supply device 70.

The gas flow path 530 is connected to the space inside the supply device 70 again at a position upstream of the filling portion 511 in the movement direction of the developer.

The gas flow path 530 is connected to the space inside the supply device 70 again at a position other than the node portion 98.

In the present exemplary embodiment, the node portion 98 at which the gas flow path 530 branches off from the developer flow path 510 is present. The gas flow path 530 is connected to the space inside the supply device 70 again at a position other than the node portion 98.

As shown in FIG. 9B, a gas from the developing device 14 first passes through the vertical flow path 514 provided as a portion of the developer flow path 510. The gas moves toward the upstream side in the movement direction of the developer through the vertical flow path 514. The gas moves upward through the vertical flow path 514.

A gas flowing from the developing device 14 to the supply device 70 passes through the developer flow path 510. Then, the gas passing through the developer flow path 510 moves toward the upstream side in the movement direction of the developer.

Hereinafter, in the present specification, a direction intersecting a perpendicular direction may be referred to as an “intersection direction”.

The filling portion 511 and the vertical flow path 514 are disposed such that the positions thereof in the intersection direction are different from each other.

A gas flowing from the developing device 14 to the supply device 70 moves upward through the vertical flow path 514, as described above. Then, the gas moves in the intersection direction.

Specifically, the gas once enters the lateral flow path 513 and then enters the gas flow path 530 positioned above the lateral flow path 513. Then, the gas moves in a leftward direction in the drawing through the gas flow path 530.

As shown in FIG. 9B, the gas flow path 530 extends in the lateral direction. In other words, the gas flow path 530 extends in the intersection direction. The gas flow path 530 is provided with a lateral portion 531 which is a portion extending in the lateral direction.

As shown in FIG. 9A, a bottom surface of the lateral portion 531 is provided with a slope 532 that is inclined with respect to a horizontal direction. The slope 532 is a slope of which the height increases toward an upstream side in a movement direction of a gas passing through the gas flow path 530.

Since the slope 532 is provided on the bottom surface, a developer is less likely to accumulate at the bottom surface. A developer placed on a portion of a bottom surface of the gas flow path 530 that is provided with the slope 532 moves by being slid. Accordingly, the developer moves in a downward and rightward direction in FIG. 9A.

The lateral flow path 513 is positioned on a downstream side in the downward and rightward direction. A developer placed on the bottom surface of the gas flow path 530 moves to the lateral flow path 513.

As shown in FIG. 9B, a space 571 is present between the filling portion 511 and the vertical flow path 514 in the intersection direction intersecting the perpendicular direction. The space 571 is a space through which both a developer and a gas pass.

A developer moving from the filling portion 511 to the vertical flow path 514 passes through the space 571. In addition, a gas moving to the filling portion 511 side from the vertical flow path 514 also passes through the space 571.

In the present exemplary embodiment, the vertical flow path 514 is a flow path along the perpendicular direction. However, the present invention is not limited thereto, and the vertical flow path 514 may be inclined with respect to the perpendicular direction. The vertical flow path 514 also includes a flow path that is disposed in a state of being inclined with respect to the perpendicular direction.

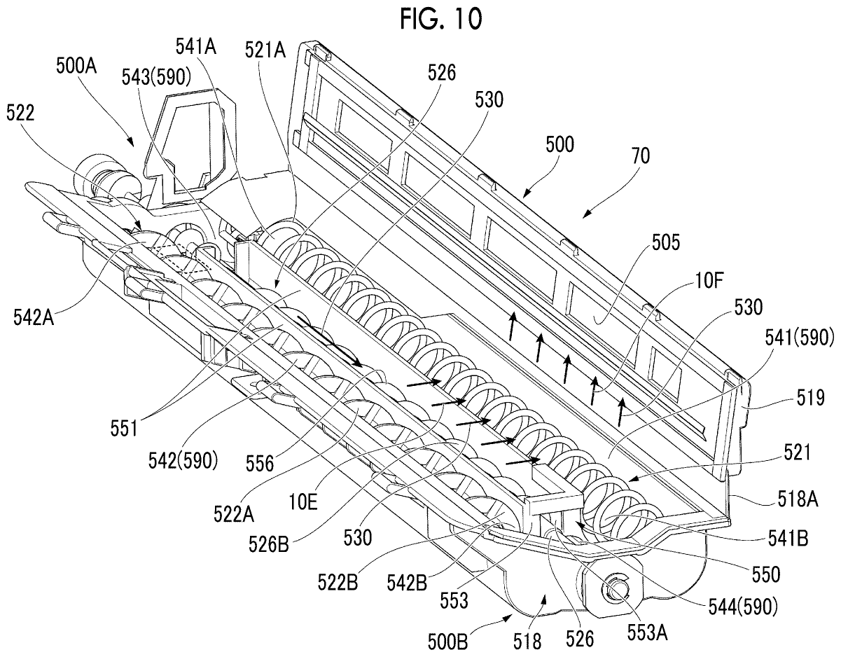

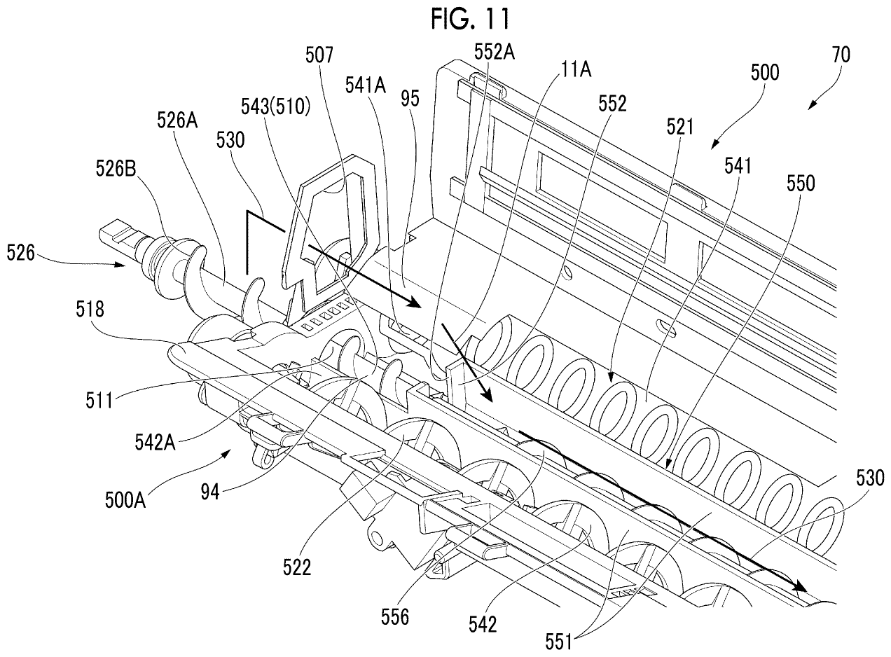

FIG. 10 is a perspective view showing the developer storage portion 500 as seen from above. FIG. 11 is an enlarged view of one end portion 500A of the developer storage portion 500.

FIG. 10 shows the developer storage portion 500 as seen from the other end portion 500B side of the developer storage portion 500.

As shown in FIG. 10, the developer storage portion 500 is provided with a lower-side container 518 having a rectangular parallelepiped shape. First, a developer supplied from the developer accommodation container 80 shown in FIG. 7 is accommodated in the lower-side container 518.

A one-direction transport member 521 that transports the developer in one direction is provided in the lower-side container 518. In addition, an opposite-direction transport member 522 that transports the developer in a direction opposite to the one direction is provided inside the lower-side container 518.

The one-direction transport member 521 and the opposite-direction transport member 522 are provided to be parallel to each other. In addition, the one-direction transport member 521 and the opposite-direction transport member 522 are provided along a longitudinal direction of the lower-side container 518.

Furthermore, a drive source (not shown) that drives the one-direction transport member 521, such as a motor, is provided. In addition, a drive source (not shown) that drives the opposite-direction transport member 522, such as a motor, is provided.

The one-direction transport member 521 is composed of a coil. In other words, the one-direction transport member 521 is composed of a wire bent in a spiral shape.

The opposite-direction transport member 522 is provided with a rod-shaped rotary shaft. The rotary shaft is provided along the longitudinal direction of the lower-side container 518.

In addition, the opposite-direction transport member 522 is provided with a protruding portion 522A that protrudes from an outer peripheral surface of the rotary shaft. The protruding portion 522A is disposed around the rotary shaft and is provided in a spiral shape.

Note that the opposite-direction transport member 522 may be a transport member composed of a coil as with the one-direction transport member 521.

Furthermore, the one-direction transport member 521 may be a transport member including a rotary shaft and a spiral protruding portion as with the opposite-direction transport member 522.

In addition, both the one-direction transport member 521 and the opposite-direction transport member 522 may be configured as transport members composed of coils.

In addition, both the one-direction transport member 521 and the opposite-direction transport member 522 may be transport members including rotary shafts and spiral protruding portions.

In the present exemplary embodiment, the coil-shaped one-direction transport member 521 rotates around a rotary shaft extending along an axial direction of the one-direction transport member 521. Accordingly, a developer is gradually moved in the axial direction of the one-direction transport member 521.

More specifically, the developer moves toward one end portion 521A of the one-direction transport member 521 in the axial direction.

In addition, in the present exemplary embodiment, the opposite-direction transport member 522 rotates around the rotary shaft.

Accordingly, a developer is pushed out by the protruding portion 522A provided on the opposite-direction transport member 522. Accordingly, the developer moves in an axial direction of the opposite-direction transport member 522.

More specifically, the developer moves toward the other end portion 522B of the opposite-direction transport member 522 in an axial direction.

Furthermore, a one-direction flow path 541, through which a developer passes in a case where the developer is to be moved in the one direction, is provided in the lower-side container 518.

Furthermore, an opposite-direction flow path 542, through which a developer passes in a case where the developer is to be moved in a direction opposite to the one direction, is provided inside the lower-side container 518.

The one-direction flow path 541 and the opposite-direction flow path 542 are provided to be parallel to each other. The one-direction flow path 541 and the opposite-direction flow path 542 are provided along the longitudinal direction of the lower-side container 518.

The one-direction transport member 521 is disposed in the one-direction flow path 541. A developer transported by the one-direction transport member 521 moves in the one-direction flow path 541.

The opposite-direction transport member 522 is disposed in the opposite-direction flow path 542. A developer transported by the opposite-direction transport member 522 moves in the opposite-direction flow path 542.

Furthermore, one end-portion-side connection flow path 543 is provided.

The one end-portion-side connection flow path 543 is provided at the one end portion 500A of the developer storage portion 500 and is provided in the lower-side container 518. The one end-portion-side connection flow path 543 connects one end portion 541A of the one-direction flow path 541 and one end portion 542A of the opposite-direction flow path 542 to each other.

In addition, the other end-portion-side connection flow path 544 is provided.

The other end-portion-side connection flow path 544 is provided at the other end portion 500B of the developer storage portion 500 and is provided in the lower-side container 518. The other end-portion-side connection flow path 544 connects the other end portion 541B of the one-direction flow path 541 and the other end portion 542B of the opposite-direction flow path 542 to each other.

Furthermore, as shown in FIG. 10, an annular wall portion 550, which is a wall portion provided in an annular shape, is provided inside the lower-side container 518.

In a case where the lower-side container 518 is seen from above, the annular wall portion 550 is annular. In addition, in a case where the lower-side container 518 is seen from above, the annular wall portion 550 is rectangular.

The annular wall portion 550 is provided between the one-direction flow path 541 and the opposite-direction flow path 542. In addition, the annular wall portion 550 is provided between the one end-portion-side connection flow path 543 and the other end-portion-side connection flow path 544.

As shown in FIG. 10, the annular wall portion 550 is provided to protrude upward from a bottom surface of the lower-side container 518. Furthermore, the annular wall portion 550 is provided along the longitudinal direction of the lower-side container 518.

The one-direction flow path 541 and the opposite-direction flow path 542 are provided near the annular wall portion 550. In addition, the one end-portion-side connection flow path 543 and the other end-portion-side connection flow path 544 are provided around the annular wall portion 550.

In the present exemplary embodiment, a developer is transported by the one-direction transport member 521 and the opposite-direction transport member 522. The transported developer moves through a space in the lower-side container 518 that is positioned around the annular wall portion 550.

The transported developer passes through the one-direction flow path 541 and then reaches the one end-portion-side connection flow path 543. Thereafter, the developer moves from the one end-portion-side connection flow path 543 to the opposite-direction flow path 542. Then, the developer moves to the other end-portion-side connection flow path 544 through the opposite-direction flow path 542. Then, the developer moves to the one-direction flow path 541 through the other end-portion-side connection flow path 544.

The transported developer circulates along a periphery of the annular wall portion 550. In the present exemplary embodiment, an annular circulation flow path 590, through which a developer circulates, is provided around the annular wall portion 550.

The circulation flow path 590 which is an example of an annular flow path consists of the one-direction flow path 541, the one end-portion-side connection flow path 543, the opposite-direction flow path 542, and the other end-portion-side connection flow path 544.

A developer transported by the one-direction transport member 521 moves toward the one end portion 541A of the one-direction flow path 541.

Then, the developer reaches the one end portion 541A. Furthermore, a developer is sequentially transported from an upstream side to the one end portion 541A by the one-direction transport member 521.

The developer that has reached the one end portion 541A is pressed by the developer transported from the upstream side. Accordingly, the developer that has reached the one end portion 541A moves to the one end-portion-side connection flow path 543.

Then, the developer moves to the opposite-direction flow path 542 through the one end-portion-side connection flow path 543.

The developer that has moved to the opposite-direction flow path 542 moves toward the other end portion 542B of the opposite-direction flow path 542.

The developer that has moved to the opposite-direction flow path 542 is moved toward the other end portion 542B by the opposite-direction transport member 522. Accordingly, the developer reaches the other end portion 542B.

Then, the developer that has reached the other end portion 542B of the opposite-direction flow path 542 moves toward the other end-portion-side connection flow path 544.

In the present exemplary embodiment, a developer is sequentially transported from the upstream side to the other end portion 542B by the opposite-direction transport member 522. The developer that has reached the other end portion 542B is pressed by the developer sequentially transported from the upstream side to the other end portion 542B.

Accordingly, the developer enters the other end-portion-side connection flow path 544. Thereafter, the developer reaches the one-direction flow path 541.

Accordingly, in the present exemplary embodiment, the developer moves around the annular wall portion 550. In other words, the developer moves along the circulation flow path 590. As a result, in the present exemplary embodiment, the developer circulates.

The annular wall portion 550 is composed of four wall portions.

The annular wall portion 550 is provided with two axial wall portions 551.

The two axial wall portions 551 extend along the axial direction of the one-direction transport member 521. Furthermore, the two axial wall portions 551 extend along the axial direction of the opposite-direction transport member 522.

In addition, the two axial wall portions 551 are disposed to face each other. In addition, the two axial wall portions 551 are disposed to be parallel to each other.

Furthermore, as shown in FIG. 11, the annular wall portion 550 is provided with one end-portion-side wall portion 552. The one end-portion-side wall portion 552 is positioned at one end portion of the annular wall portion 550 in a longitudinal direction. The one end-portion-side wall portion 552 connects the two axial wall portions 551 to each other.

Furthermore, as shown in FIG. 10, the annular wall portion 550 is provided with the other end-portion-side wall portion 553. The other end-portion-side wall portion 553 is positioned at the other end portion of the annular wall portion 550 in the longitudinal direction. The other end-portion-side wall portion 553 connects the two axial wall portions 551 to each other.

Furthermore, as shown in FIG. 11, an opening 507 through which the gas flow path 530 extends is provided at the one end portion 500A of the developer storage portion 500. A gas that flows from the developing device 14 and that passes through the gas flow path 530 passes through the opening 507.

Furthermore, as shown in FIG. 10, a wall portion 519 extending upward is provided.

The wall portion 519 is provided above one side wall 518A extending in the longitudinal direction of the lower-side container 518.

The side wall 518A extending in the longitudinal direction of the lower-side container 518 is provided as one of four side walls of the lower-side container 518. The wall portion 519 is provided above the side wall 518A extending in the longitudinal direction of the lower-side container 518.

The wall portion 519 is provided to extend along the longitudinal direction of the lower-side container 518.

The wall portion 519 is provided with the openings 505 used to discharge a gas flowing from the developing device 14. Through the openings 505, the inside of the supply device 70 and the outside of the supply device 70 communicate with each other.

A plurality of the openings 505 are provided. The plurality of openings 505 are arranged in the longitudinal direction of the lower-side container 518.

Furthermore, each of the openings 505 is provided to extend in an axial direction of the developer accommodation container 80 mounted to the mounting target portion 701 shown in FIG. 7.

A gas passing through the gas flow path 530 (refer to FIG. 11) is discharged to the outside of the supply device 70 through the openings 505 at the end.

As shown in FIG. 11, a wall portion internal space 556, which is a space positioned inside the annular wall portion 550, is provided inside the annular wall portion 550.

In the present exemplary embodiment, a gas flowing through the gas flow path 530 enters the wall portion internal space 556 as represented by an arrow 11A.

Thereafter, the gas moves toward the other end portion 500B side of the developer storage portion 500 (refer to FIG. 10) through the wall portion internal space 556.

Thereafter, the gas moves toward the one-direction flow path 541 as represented by arrows 10E in FIG. 10.

Then, the gas moves along the wall portion 519 as represented by arrows 10F and moves toward the openings 505 formed in the wall portion 519. Then, the gas moves to the outside of the supply device 70 through the openings 505.

As shown in FIG. 11, the one end portion 500A of the developer storage portion 500 is provided with the filling portion 511 described above.

Furthermore, a central transport member 526 disposed through the filling portion 511 is provided. The central transport member 526 is provided at the central portion of the lower-side container 518 in a transverse direction of the lower-side container 518.

The central transport member 526 is disposed between the one-direction transport member 521 and the opposite-direction transport member 522. In addition, the central transport member 526 is provided along the longitudinal direction of the lower-side container 518.

Furthermore, a drive source (not shown) that drives the central transport member 526, such as a motor, is provided.

The central transport member 526 includes a rod-shaped rotary shaft 526A and protruding portions 526B.

The protruding portions 526B are disposed around the rotary shaft 526A and are provided in spiral shapes. In addition, the protruding portions 526B are provided to protrude from an outer peripheral surface of the rotary shaft 526A.

In the present exemplary embodiment, the central transport member 526 is caused to rotate about the rotary shaft 526A by the drive source. Accordingly, a developer is pushed out by the protruding portions 526B, and the developer moves in an axial direction of the central transport member 526.

In the present exemplary embodiment, a developer in the one end-portion-side connection flow path 543 is sent to the filling portion 511 by the central transport member 526.

A developer transported by the one-direction transport member 521 accumulates at the one end-portion-side connection flow path 543.

A pre-filling space 94 is provided between the filling portion 511 and the one end-portion-side wall portion 552.

The one end-portion-side connection flow path 543 passes through the pre-filling space 94. The developer transported by the one-direction transport member 521 accumulates at the pre-filling space 94.

In the present exemplary embodiment, the developer accumulated at the pre-filling space 94 is pushed into the filling portion 511 by the central transport member 526.

Accordingly, the filling portion 511 is filled with the developer and then the developer is supplied to a downstream side.

A developer passing through the filling portion 511 moves toward the lateral flow path 513 (refer to FIG. 9B) positioned downstream of the filling portion 511. Thereafter, the developer moves toward the developing device 14 through the vertical flow path 514.

As shown in FIG. 10, the central transport member 526 is provided over an area from one end portion of the lower-side container 518 in the longitudinal direction to the other end portion of the lower-side container 518 in the longitudinal direction.

In addition, the central transport member 526 is provided through the annular wall portion 550. In other words, the central transport member 526 is provided such that a portion of the central transport member 526 is positioned in the wall portion internal space 556.

As shown in FIG. 11, a groove 552A is formed at the one end-portion-side wall portion 552 of the annular wall portion 550. The central transport member 526 is disposed through the groove 552A.

Since the one end-portion-side wall portion 552 is provided, a developer is restrained from entering the wall portion internal space 556. More specifically, a developer in the pre-filling space 94 is restrained from entering the wall portion internal space 556.

In addition, as shown in FIG. 10, the other end-portion-side wall portion 553 of the annular wall portion 550 is provided with an opening 553A. The central transport member 526 is provided through the opening 553A.

In the present exemplary embodiment, a developer is restrained from entering the wall portion internal space 556 since the other end-portion-side wall portion 553 is provided. More specifically, a developer in the other end-portion-side connection flow path 544 is restrained from entering the wall portion internal space 556.

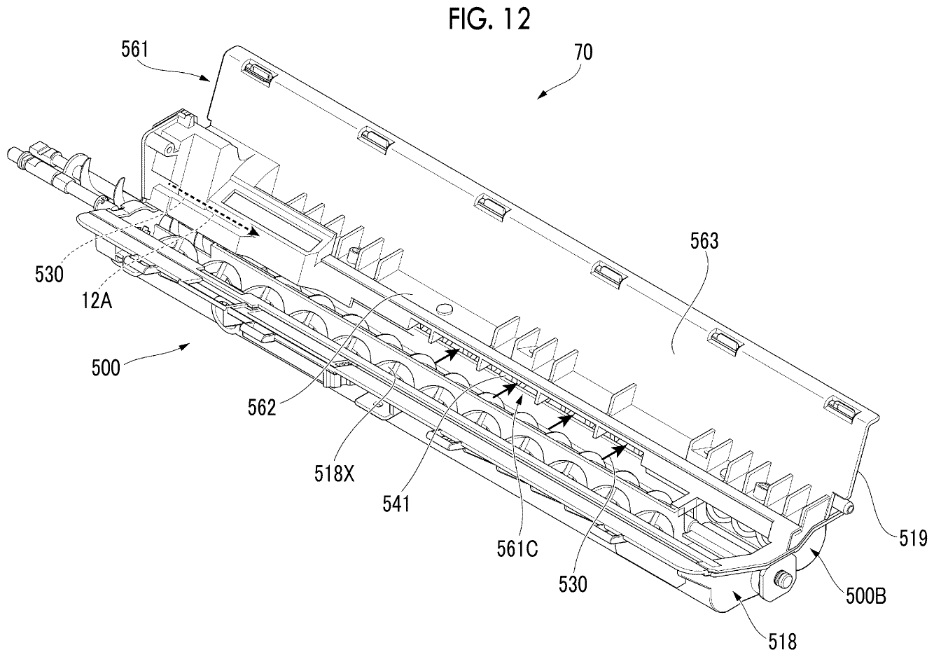

FIG. 12 is a view showing a state where an upper-side member 561 is attached onto the lower-side container 518.

In the supply device 70, the upper-side member 561 is attached to the lower-side container 518.

The upper-side member 561 includes a blocking portion 562. The blocking portion 562 is provided to extend in a horizontal direction. The blocking portion 562 blocks a portion of an opening 518X positioned at an upper portion of the lower-side container 518.

The upper-side member 561 further includes a wall portion 563.

The wall portion 563 is connected to the blocking portion 562. The wall portion 563 is provided to extend upward from the blocking portion 562.

The wall portion 563 is provided to face the wall portion 519 provided at the lower-side container 518. A gap for passage of a gas is provided between the wall portion 563 and the wall portion 519.

In other words, a space for passage of a gas is provided between the wall portion 563 and the wall portion 519.

A gas passes through the opening 507 provided at the one end portion 500A of the developer storage portion 500 shown in FIG. 11.

The gas passing through the opening 507 moves as represented by an arrow 12A in FIG. 12.

As represented by the arrow 12A, the gas passing through the opening 507 passes through a gap between the lower-side container 518 and the upper-side member 561. Furthermore, the gas moves toward the other end portion 500B side of the developer storage portion 500.

The gas flow path 530 shown in FIG. 11 is provided between the lower-side container 518 and the upper-side member 561. Note that in FIG. 11, the upper-side member 561 is not shown.

The gas passing through the opening 507 passes through the gas flow path 530 positioned between the lower-side container 518 and the upper-side member 561. Then, as represented by the arrow 12A in FIG. 12, the gas moves toward the other end portion 500B side of the developer storage portion 500.

Thereafter, the gas enters the wall portion internal space 556 as represented by the arrow 11A in FIG. 11. Then, the gas moves toward the other end portion 500B (refer to FIG. 12) side of the developer storage portion 500 through the wall portion internal space 556.

Thereafter, the gas moves toward the one-direction flow path 541 through a recess portion 561C provided at a lower surface of the upper-side member 561 shown in FIG. 12.

The gas moves to a space positioned between the wall portion 563 and the wall portion 519 through a position above the one-direction flow path 541.

Then, the gas moves upward through the space. Then, the gas moves to the outside of the supply device 70 through the openings 505 that are formed in the wall portion 519 and that are shown in FIG. 10.

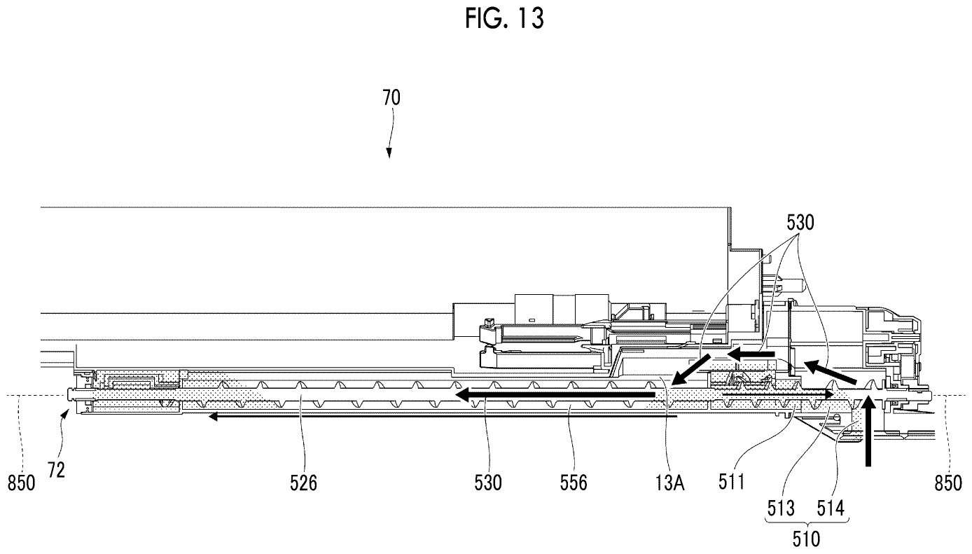

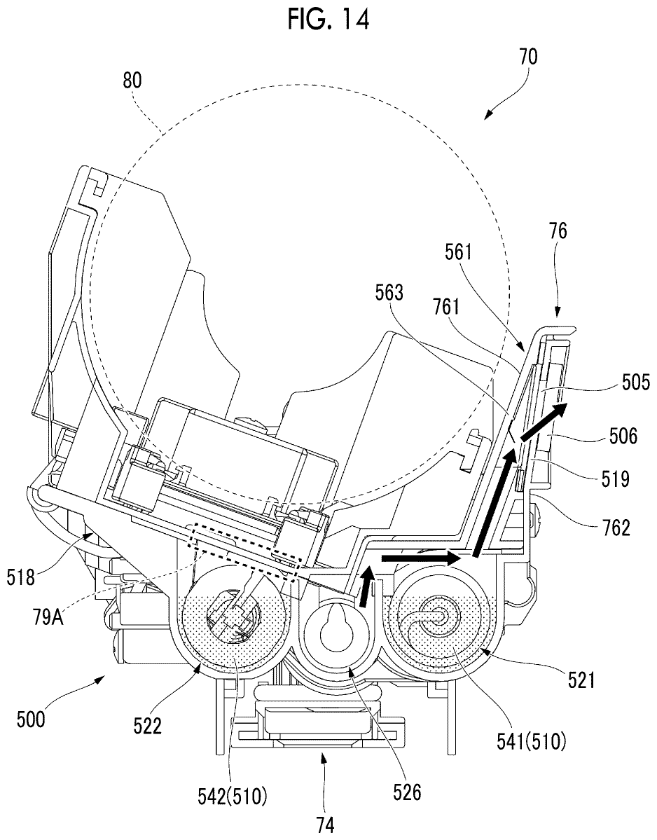

FIG. 13 is a cross-sectional view of the supply device 70 taken along line XIII-XIII of FIG. 7. Note that in FIG. 13, the developer accommodation container 80 shown in FIG. 7 is not shown.

The way in which a gas flows in the supply device 70 will be further described with reference to FIG. 13.

In the present exemplary embodiment, first, a gas from the developing device 14 described above enters the supply device 70. Then, the gas moves upward through the vertical flow path 514 constituting a portion of the developer flow path 510.

Thereafter, the gas moves toward the other end portion 72 side of the supply device 70 through the gas flow path 530 provided to branch off from the developer flow path 510.

The gas flow path 530 is connected to the space inside the supply device 70 again at the position represented by the reference numeral 13A.

The wall portion internal space 556 positioned inside the annular wall portion 550 shown in FIG. 10 is present below the position represented by the reference numeral 13A.

At the position represented by the reference numeral 13A, the gas flow path 530 is connected to the wall portion internal space 556 positioned inside the annular wall portion 550. The wall portion internal space 556 is a space positioned in the supply device 70.

Thereafter, the gas flow path 530 passes through the wall portion internal space 556. Accordingly, in the present exemplary embodiment, a gas enters the wall portion internal space 556.

The gas entering the wall portion internal space 556 moves along a longitudinal direction of the wall portion internal space 556.

The gas flow path 530 passes through the wall portion internal space 556. The gas flow path 530 is provided to extend in the longitudinal direction of the wall portion internal space 556. Therefore, the gas entering the wall portion internal space 556 moves along the longitudinal direction of the wall portion internal space 556.

The gas flow path 530 passes through the wall portion internal space 556 and then extends toward the recess portion 561C shown in FIG. 12. A gas passing through the gas flow path 530 moves to the recess portion 561C.

Thereafter, the gas flow path 530 extends toward the openings 505 shown in FIG. 10 through an upper portion of the one-direction flow path 541. The gas flow path 530 extends toward the openings 505 through the upper portion of the one-direction flow path 541 and the space between the wall portion 563 and the wall portion 519.

A gas in the wall portion internal space 556 reaches the upper portion of the one-direction flow path 541 through the recess portion 561C. Thereafter, the gas reaches the openings 505 formed in the wall portion 519 shown in FIG. 10. Then, the gas moves to the outside of the supply device 70 through the openings 505.

FIG. 14 is a cross-sectional view of the supply device 70 in a plane orthogonal to a longitudinal direction of the developer accommodation container 80. In FIG. 14, the developer accommodation container 80 is represented by a broken line.

The supply device 70 is provided with a protruding portion 76 that extends obliquely upward and that is hollow. In the present exemplary embodiment, the protruding portion 76 is provided with the openings 505.

In the present exemplary embodiment, the lower-side container 518 is provided with the wall portion 519. In addition, the upper-side member 561 is provided with the wall portion 563.

In the present exemplary embodiment, the wall portion 519 and the wall portion 563 constitute the protruding portion 76. The wall portion 563 and the wall portion 519 protrude upward. In addition, the wall portion 563 and the wall portion 519 are disposed to face each other.

In the present exemplary embodiment, a portion of the protruding portion 76 extending upward is positioned beside the developer accommodation container 80.

The protruding portion 76 includes a facing surface 761 that faces the developer accommodation container 80. In addition, the protruding portion 76 includes an opposite surface 762 positioned on a side opposite to the facing surface 761.

The openings 505 are provided in the opposite surface 762 which is one of a plurality of surfaces of the protruding portion 76. The openings 505 are provided to face a side opposite to a side on which the developer accommodation container 80 is installed.

In this case, a gas is likely to be discharged through the openings 505 in comparison with a case where the openings 505 face the side on which the developer accommodation container 80 is installed.

Note that as described above, the filter 506 is installed at the position facing the openings 505.

In addition, the supply device 70 is provided with a reception port 79A through which a developer from the developer accommodation container 80 is received. Furthermore, the supply device 70 is provided with the discharge port 74 used to discharge a developer.

The openings 505 provided at the protruding portion 76 are openings through which the inside of the supply device 70 and the outside of the supply device 70 communicate with each other.

In the supply device 70, the openings 505 are provided separately from the reception port 79A and the discharge port 74. A gas flowing from the developing device 14 is discharged to the outside of the supply device 70 through the openings 505.

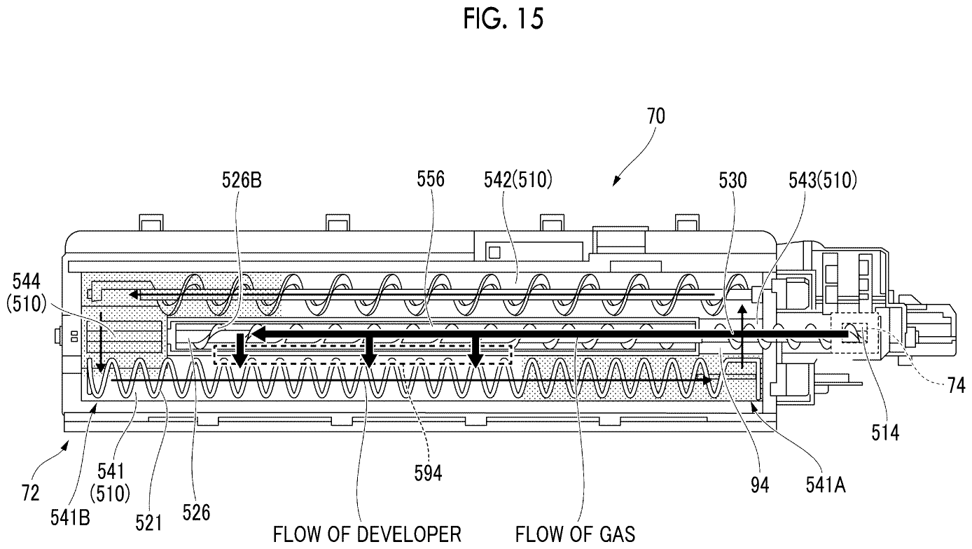

FIG. 15 is a view showing the way in which a gas flows regarding a case where the supply device 70 is seen from above. In FIG. 15, the upper-side member 561 and the like are not shown.

A gas flowing from the developing device 14 enters the supply device 70 through the discharge port 74 provided at the supply device 70. The gas entering the supply device 70 passes through the vertical flow path 514 and then enters the gas flow path 530.

Then, the gas moves toward the wall portion internal space 556 through the gas flow path 530. Then, the gas moves toward the other end portion 72 side of the supply device 70 through the wall portion internal space 556.

The gas flow path 530 is provided to pass through the wall portion internal space 556. Therefore, the gas moves toward the other end portion 72 side of the supply device 70 through the wall portion internal space 556.

No developer is transported in the wall portion internal space 556. Therefore, the amount of a developer in the wall portion internal space 556 is small.

Next, the gas moves from the wall portion internal space 556 to the one-direction flow path 541.

Thereafter, the gas moves toward the openings 505 provided at the protruding portion 76 through a space in the protruding portion 76 shown in FIG. 14.

The central transport member 526 is provided in the wall portion internal space 556 as well.

The central transport member 526 moves a developer accumulated in the wall portion internal space 556.

A gas passing through the gas flow path 530 is supplied to the wall portion internal space 556. In this case, a developer contained in the gas accumulates in the wall portion internal space 556.

The developer accumulating in the wall portion internal space 556 is transported to the pre-filling space 94 by the central transport member 526. The developer in the wall portion internal space 556 is discharged from the wall portion internal space 556.

The central transport member 526 transports the developer in the wall portion internal space 556 toward the pre-filling space 94 positioned on the developer flow path 510.

As shown in FIG. 11, the one end-portion-side wall portion 552 is provided at one end portion of the wall portion internal space 556 in the longitudinal direction. The one end-portion-side wall portion 552 is provided with the groove 552A.

The developer transported by the central transport member 526 moves to the pre-filling space 94 through the groove 552A.

The central transport member 526 is disposed not only in the developer flow path 510 but also in the gas flow path 530. Accordingly, a developer in the gas flow path 530 is also moved.

The central transport member 526 will be further described with reference to FIG. 9B.

The central transport member 526 is provided with an in-tubular-portion part 526E positioned in the tubular portion 512. In addition, the central transport member 526 is provided with an external part 526F that is positioned outside the tubular portion 512.

In the transport direction of the developer, the external part 526F is positioned downstream of the in-tubular-portion part 526E. The external part 526F is positioned in the lateral flow path 513 that constitutes a portion of the developer flow path 510.

In the present exemplary embodiment, the developer transport performance of the external part 526F is higher than the developer transport performance of the in-tubular-portion part 526E.

The in-tubular-portion part 526E is provided with the protruding portions 526B. In addition, the external part 526F is also provided with the protruding portions 526B.

Hereinafter, the protruding portions 526B provided on the in-tubular-portion part 526E will be referred to as “internal protruding portions”. In addition, the protruding portions 526B provided on the external part 526F will be referred to as “external protruding portions”. In the present exemplary embodiment, it can be found that the outer diameter of the external protruding portions is larger than the outer diameter of the internal protruding portions in a case where the outer diameters of the protruding portions 526B are compared with each other.

Each of the in-tubular-portion part 526E and the external part 526F is provided with the rotary shaft 526A extending along the developer flow path 510.

Furthermore, each of the in-tubular-portion part 526E and the external part 526F is provided with a push-out portion that pushes out a developer.

The push-out portion provided at the in-tubular-portion part 526E is composed of the above-described internal protruding portion. The push-out portion provided at the external part 526F is composed of the above-described external protruding portion.

The push-out portion is provided around the rotary shaft 526A and is provided in a spiral shape.

Each of the in-tubular-portion part 526E and the external part 526F pushes out a developer by using the protruding portions 526B. The developer is transported by being pushed out in such a manner.

Here, the arrangement pitch of the internal protruding portions provided in the in-tubular-portion part 526E will be referred to as an arrangement pitch P1. In addition, the arrangement pitch of the external protruding portions provided on the external part 526F will be referred to as an arrangement pitch P2.

In the present specification, the “arrangement pitch” refers to a distance between protruding portions that are adjacent to each other.

In the present exemplary embodiment, the arrangement pitch P2 is larger than the arrangement pitch P1. More specifically, in the present exemplary embodiment, the arrangement pitch P2 is equal to or larger than 1.1 times the arrangement pitch P1.

In this case, the speed of developer transportation in the lateral flow path 513 is higher than the speed of developer transportation in the tubular portion 512.

Here, the speed of developer transportation in the tubular portion 512 will be referred to as an “internal transportation speed”. In addition, the speed of developer transportation in the lateral flow path 513 will be referred to as an “external transportation speed”. In the present exemplary embodiment, the external transportation speed is higher than the internal transportation speed.

In addition, the height of the upper surface of a developer positioned in the tubular portion 512 will be referred to as an “internal height”. In addition, the height of the upper surface of a developer positioned in the lateral flow path 513 will be referred to as an “external height”.

In the present exemplary embodiment, the external height is smaller than the internal height.

As in the present exemplary embodiment, in a case where the external transportation speed is higher than the internal transportation speed, the external height is smaller than the internal height.

In a case where the external height is smaller than the internal height, the height of the upper surface of a developer is small in comparison with a case where the external height is not smaller than the internal height. Specifically, the height of the upper surface of the developer is small at a position where the external part 526F is provided.

In this case, a developer positioned below the gas flow path 530 is less likely to enter the gas flow path 530. In addition, in this case, the cross-sectional area of the gas flow path 530 is made large.

In addition, in a case where the external height is smaller than the internal height, a gas flows in the vertical flow path 514 easily in comparison with a case where the external height is not smaller than the internal height.

In a case where the external height is smaller than the internal height, the area of occupation of a developer is reduced in comparison with a case where the external height is not smaller than the internal height. Specifically, the area of occupation of a developer is reduced in a cross section of the vertical flow path 514.

In this case, a gas moving upward through the vertical flow path 514 flows easily.

A structure around the gas flow path 530 will be further described with reference to FIG. 9B.

The gas flow path 530 includes an upstream-side end portion 530C provided at a right end portion in the drawing. The upstream-side end portion 530C is an end portion positioned closest to an upstream side in a movement direction of a gas in the gas flow path 530.

The vertical flow path 514 includes an upstream-side end portion 514D and a downstream-side end portion 514C.

The position of the upstream-side end portion 514D is different from the position of the downstream-side end portion 514C. The positions of the upstream-side end portion 514D and the downstream-side end portion 514C in the movement direction of a gas in the gas flow path 530 are different from each other.

In the movement direction of a gas in the gas flow path 530, the upstream-side end portion 530C is positioned upstream of the downstream-side end portion 514C.

Here, the position of the upstream-side end portion 530C of the gas flow path 530 will be compared with the position of the downstream-side end portion 514C of the vertical flow path 514.

In the present exemplary embodiment, the upstream-side end portion 530C is positioned upstream of the downstream-side end portion 514C. In the movement direction of a gas in the gas flow path 530, the upstream-side end portion 530C is positioned upstream of the downstream-side end portion 514C.

In FIG. 9B, the movement direction of a gas in the gas flow path 530 is a direction from the right side to the left side in FIG. 9B.

In a case where the upstream-side end portion 530C is positioned upstream of the downstream-side end portion 514C, a gas flows easily. The gas flows easily in comparison with a case where the upstream-side end portion 530C is positioned downstream of the downstream-side end portion 514C.

For example, a case where the upstream-side end portion 530C of the gas flow path 530 is positioned at a position represented by a reference numeral “9X” will be assumed. That is, a case where the upstream-side end portion 530C is positioned downstream of the downstream-side end portion 514C of the vertical flow path 514 will be assumed.

In this case, a flow path through which a gas flows is narrowed, and it is difficult for the gas to flow.

However, in a case where the upstream-side end portion 530C is positioned upstream of the downstream-side end portion 514C, the flow path through which the gas flows is widened. In this case, the gas flows more easily.

Note that a case where the in-tubular-portion part 526E and the external part 526F are composed of one common member has been described above as an example.

Specifically, a case where the in-tubular-portion part 526E and the external part 526F are composed of one central transport member 526 has been described as an example.

However, the present invention is not limited thereto, and the in-tubular-portion part 526E and the external part 526F may be individually provided. A member that has a role as the in-tubular-portion part 526E and a member that has a role as the external part 526F may be individually provided.

### Second Exemplary Embodiment

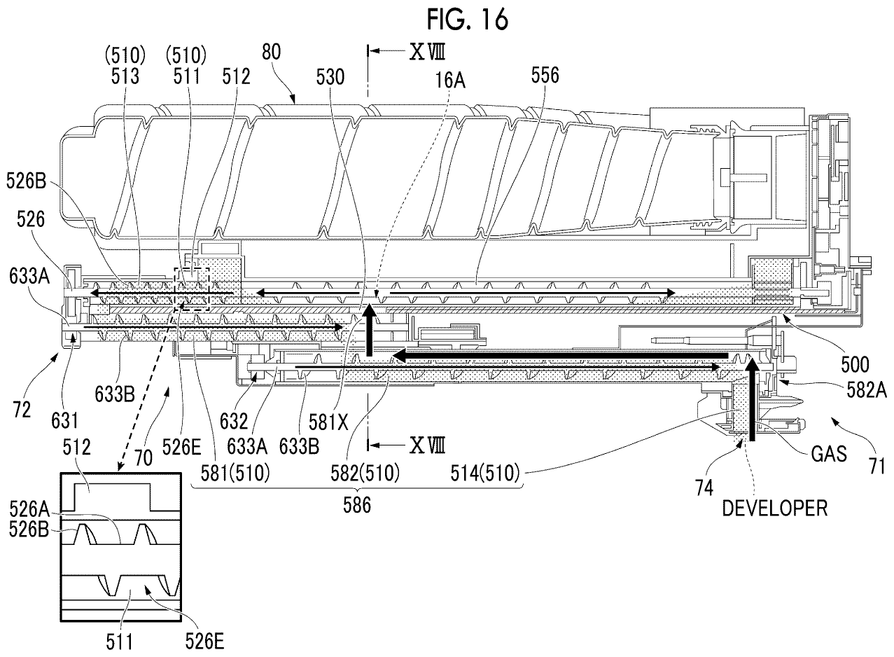

FIG. 16 is a view showing the supply device 70 according to a second exemplary embodiment.

Hereinafter, portions different from the first exemplary embodiment, which is an exemplary embodiment shown in FIGS. 7 to 15, will be described.

In the supply device 70 shown in FIG. 16, the filling portion 511 is positioned on the other end portion 72 side of the supply device 70.

Furthermore, in the supply device 70, an intermediate flow path 581 constituting a portion of the developer flow path 510 is provided below the developer storage portion 500.

Furthermore, a lower-side flow path 582 constituting another portion of the developer flow path 510 is provided below the intermediate flow path 581.

An intermediate transport member 631 that transports a developer in the intermediate flow path 581 is provided in the intermediate flow path 581. A lower-side transport member 632 that transports a developer in the lower-side flow path 582 is provided in the lower-side flow path 582.

Each of the intermediate transport member 631 and the lower-side transport member 632 includes a rotary shaft 633A. In addition, each of the intermediate transport member 631 and the lower-side transport member 632 includes a protruding portion 633B.

In addition, the protruding portions 633B are provided to protrude from outer peripheral surfaces of the rotary shafts 633A and are provided in spiral shapes. The protruding portions 633B have a function as a push-out portion that pushes out a developer.

Furthermore, the supply device 70 is provided with a drive source (not shown) for the rotational driving of the intermediate transport member 631. In addition, a drive source (not shown) for the rotational driving of the lower-side transport member 632 is provided.

In the second exemplary embodiment, a developer passing through the filling portion 511 moves toward the lateral flow path 513. Thereafter, the developer reaches the intermediate flow path 581 positioned below the developer storage portion 500. Then, the developer moves, through the intermediate flow path 581, toward the lower-side flow path 582 positioned below the intermediate flow path 581.

Then, the developer moves toward one end portion 582A of the lower-side flow path 582 through the lower-side flow path 582.

Thereafter, the developer moves toward the discharge port 74 through the vertical flow path 514 extending downward from the one end portion 582A of the lower-side flow path 582.

In the second exemplary embodiment, the gas flow path 530 is provided at a position represented by a reference numeral “16A” in the drawing.

As in the above description, the gas flow path 530 is provided to branch off from the developer flow path 510.

Specifically, the gas flow path 530 is provided to branch off from the intermediate flow path 581. The gas flow path 530 extends toward the developer storage portion 500 positioned on an upper side from a node portion 581X at which the gas flow path 530 branches off from the intermediate flow path 581.

In the second exemplary embodiment, the gas flow path 530 is provided with a portion that extends in the perpendicular direction. In other words, the gas flow path 530 is provided with a portion that extends in the vertical direction.

Note that the gas flow path 530 may be disposed in a state of being inclined with respect to the perpendicular direction.

In the second exemplary embodiment as well, a gas enters the supply device 70 through the discharge port 74.

Then, the gas moves toward an upstream side in a movement direction of a developer through a downstream-side portion 586 of the developer flow path 510.

Here, the “downstream-side portion 586” refers to a portion of the developer flow path 510 that is positioned downstream of the filling portion 511.

Here, the movement direction of the developer moving in the developer flow path 510 will be assumed.

The “downstream-side portion 586” refers to a portion positioned downstream of the filling portion 511 in the movement direction.

In the second exemplary embodiment, the downstream-side portion 586 is composed of the lateral flow path 513, the intermediate flow path 581, the lower-side flow path 582, and the vertical flow path 514.

The gas entering the supply device 70 through the discharge port 74 moves toward the upstream side in the movement direction of the developer. The gas moves toward the upstream side in the movement direction of the developer through the downstream-side portion 586.

Thereafter, the gas enters the gas flow path 530 provided to branch off from the downstream-side portion 586 and moves upward.

The gas flow path 530 is provided to branch off from the intermediate flow path 581 that constitutes a portion of the downstream-side portion 586. The gas enters the gas flow path 530 provided to branch off from the intermediate flow path 581 and moves upward.

Thereafter, the gas enters the wall portion internal space 556 provided in the developer storage portion 500.

The gas flow path 530 is connected to the wall portion internal space 556 from a bottom portion side of the wall portion internal space 556. In other words, the gas flow path 530 leads to the inside of the wall portion internal space 556 from the bottom portion side.

The gas flow path 530 leads to the inside of the wall portion internal space 556 and then extends in a leftward direction in the drawing. In addition, the gas flow path 530 leads to the inside of the wall portion internal space 556 and then extends in a rightward direction in the drawing.

In the second exemplary embodiment, developer transport performance at the downstream-side portion 586 is higher than developer transport performance at the filling portion 511.

The filling portion 511 is provided with the central transport member 526 disposed through the filling portion 511.

In the second exemplary embodiment, the developer transport performance of the central transport member 526 is higher than the developer transport performance of the intermediate transport member 631. Furthermore, the developer transport performance of the lower-side transport member 632 is higher than the developer transport performance of the central transport member 526.

In the second exemplary embodiment, the gas entering the supply device 70 moves toward the upstream side in the movement direction of the developer through the developer flow path 510. Thereafter, the gas enters the gas flow path 530 that branches off from the developer flow path 510.

More specifically, the gas entering the supply device 70 moves toward the upstream side in the movement direction of the developer through the downstream-side portion 586. Then, the gas enters the gas flow path 530 that branches off from the downstream-side portion 586.

Thereafter, the gas passes through the wall portion internal space 556 and an upper portion of the one-direction flow path 541, as in the above description. Furthermore, the gas passes through a space inside the protruding portion 76. Then, the gas reaches the openings 505 and is discharged to the outside of the supply device 70. Note that in FIG. 16, the one-direction flow path 541, the protruding portion 76, and the openings 505 are not shown.

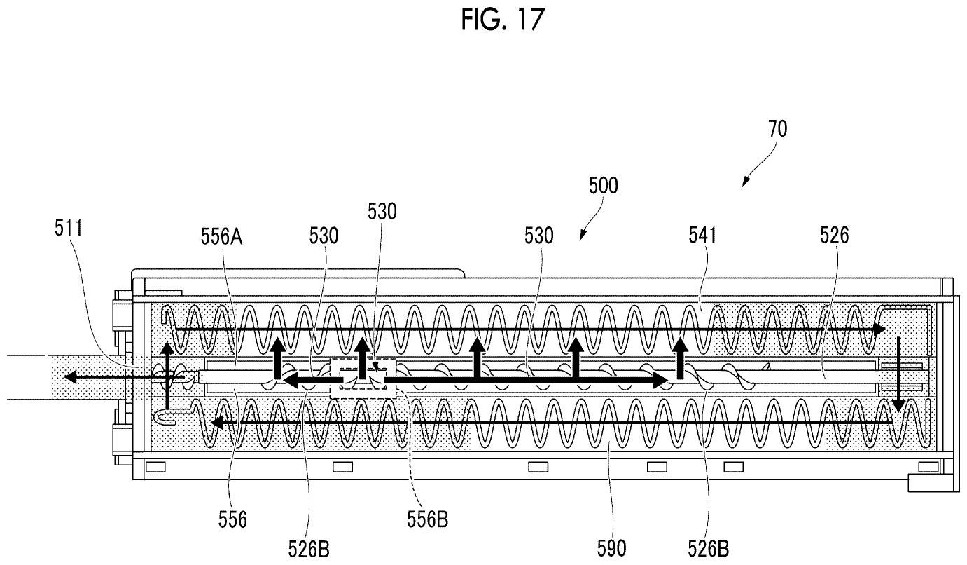

FIG. 17 is a view showing the developer storage portion 500 of the second exemplary embodiment as seen from above.

In the second exemplary embodiment, the gas flow path 530 extends toward the wall portion internal space 556 from a position below the wall portion internal space 556. In addition, the gas flow path 530 is connected to a bottom portion 556A of the wall portion internal space 556.

The bottom portion 556A is provided with an opening 556B for passage to the gas flow path 530.

The gas flow path 530 leads to the inside of the wall portion internal space 556 from the bottom portion 556A side of the wall portion internal space 556. Specifically, the gas flow path 530 leads to the inside of the wall portion internal space 556 through the opening 556B. The gas flow path 530 extends in the longitudinal direction of the wall portion internal space 556.

A gas enters the wall portion internal space 556 through the gas flow path 530. The gas enters the wall portion internal space 556 through the bottom portion 556A of the wall portion internal space 556. The gas enters the wall portion internal space 556 through the opening 556B.

Then, the gas moves along the longitudinal direction of the wall portion internal space 556.

Thereafter, as in the above description, the gas moves to a space inside the protruding portion 76 through a position above the one-direction flow path 541. Note that in FIG. 17, the protruding portion 76 is not shown.

Then, the gas passes through the space inside the protruding portion 76 and is discharged to the outside of the supply device 70 through the openings 505 provided at a side portion of the protruding portion 76.

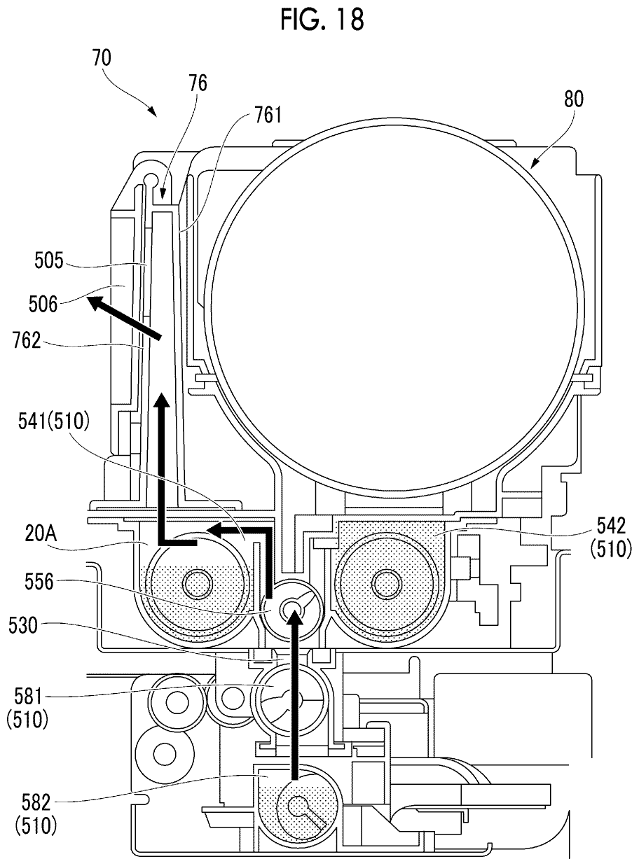

FIG. 18 is a cross-sectional view of the supply device 70 taken along line XVIII-XVIII of FIG. 16. FIG. 18 shows the supply device 70 as seen from the one end portion 71 side of the supply device 70.

In the second exemplary embodiment as well, the protruding portion 76 extending upward is provided above the one-direction flow path 541.

Similar to the first exemplary embodiment shown in FIGS. 7 to 15, the space inside the protruding portion 76 shown in FIG. 18 is connected to the one-direction flow path 541.

As in the above description, the protruding portion 76 is hollow. Inside the protruding portion 76, a space for passage of a gas is present.

A gas reaching a position above the one-direction flow path 541 passes through the space inside the protruding portion 76. Then, the gas moves toward the openings 505 provided at the side portion of the protruding portion 76. Then, the gas is discharged to the outside of the supply device 70 through the openings 505 for discharge of the gas.

In the present exemplary embodiment, the gas flow path 530 reaches the openings 505 at the end. A gas passing through the gas flow path 530 is discharged through the openings 505 at the end.

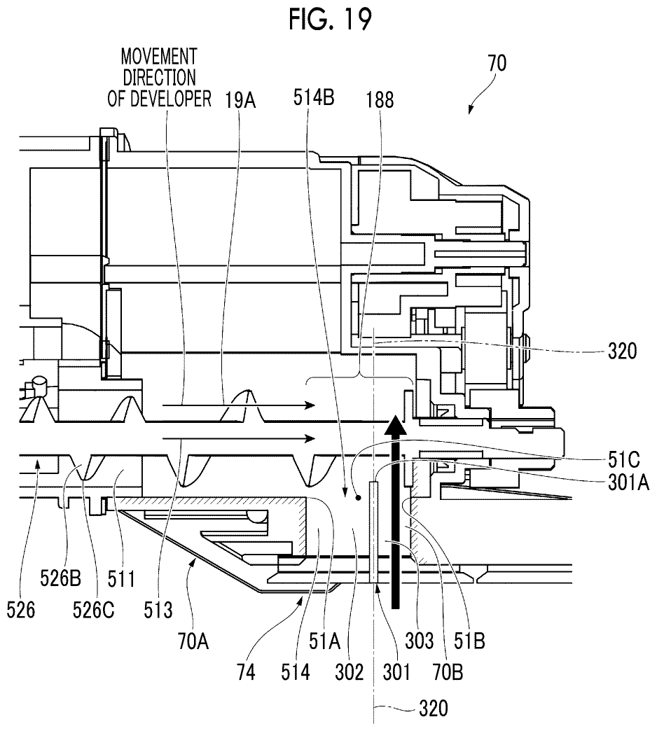

FIG. 19 is a view showing another configuration example of the supply device 70 of the first exemplary embodiment. In FIG. 19, a structure around the discharge port 74 is shown in an enlarged manner.

In the first exemplary embodiment, the lateral flow path 513 is provided as described above.

The lateral flow path 513 which is an example of an intersection direction flow path extends in the intersection direction which is a direction intersecting the perpendicular direction. In the present exemplary embodiment, a developer passes through the lateral flow path 513.

In this configuration example shown in FIG. 19, a partition 301 that partitions a space inside the vertical flow path 514 is provided in the vertical flow path 514.

The partition 301 is fixed to, for example, an inner wall 70B of a body portion 70A of the supply device 70.

The partition 301 is composed of a plate-shaped member. In addition, the partition 301 is provided in a state of being along the vertical direction. More specifically, the partition 301 is provided in a state of being along the perpendicular direction.

The vertical flow path 514, which is an example of a downward flow path, is a flow path through which a developer that has moved through the lateral flow path 513 passes.

In a case where the vertical flow path 514 extends downward from a starting point, the starting point being a position at which the vertical flow path 514 is connected to the lateral flow path 513. The vertical flow path 514 is a flow path through which a developer moving downward from the lateral flow path 513 passes.

In the present exemplary embodiment, the space inside the vertical flow path 514 is partitioned into an upstream-side space 302 and a downstream-side space 303 by the partition 301.

The upstream-side space 302 is a space positioned on an upstream side in a movement direction of a developer in the lateral flow path 513. In addition, the downstream-side space 303 is a space positioned on a downstream side in the movement direction of the developer in the lateral flow path 513.

In the movement direction of the developer in the lateral flow path 513, the downstream-side space 303 is positioned downstream of the upstream-side space 302.

In FIG. 19, the movement direction of the developer in the lateral flow path 513 is represented by an arrow 19A. Hereinafter, the movement direction of the developer in the lateral flow path 513 will be simply referred to as a “developer movement direction”.

An upper end portion of the vertical flow path 514 is provided with an opening 514B facing an upper side. A developer that has moved through the lateral flow path 513 enters the vertical flow path 514 through the opening 514B.

In the present exemplary embodiment, an upper end portion 301A of the partition 301 is positioned above the opening 514B.

The central transport member 526 is provided in the lateral flow path 513. A developer in the lateral flow path 513, which is an example of the intersection direction flow path, is transported by the central transport member 526 toward a side on which the opening 514B is positioned.

The central transport member 526 is provided along the lateral flow path 513. The central transport member 526 extends in a direction intersecting the perpendicular direction.

The central transport member 526 transports, toward a faced position 188 that the opening 514B faces, a developer from a position separated from the faced position 188. The central transport member 526 transports, toward the faced position 188 that the opening 514B faces, a developer positioned at a position separated from the faced position 188.

In the present exemplary embodiment, the upper end portion 301A of the partition 301 is positioned above a lower end portion 526C of the central transport member 526.

The opening 514B includes an upstream-side end portion 51A, which is an end portion positioned on the upstream side in the developer movement direction. In addition, the opening 514B includes a downstream-side end portion 51B, which is an end portion positioned on the downstream side in the developer movement direction.

The upstream-side end portion 51A is positioned upstream of, in the developer movement direction, a central portion 51C of the opening 514B in the developer movement direction. In addition, the downstream-side end portion 51B is positioned downstream of, in the developer movement direction, the central portion 51C.

The downstream-side end portion 51B is positioned on a side opposite to a side, on which the upstream-side end portion 51A is positioned, with the central portion 51C of the opening 514B interposed therebetween.

The partition 301 partitions the space in the vertical flow path 514 into the upstream-side space 302 positioned on the upstream-side end portion 51A side and the downstream-side space 303 positioned on the downstream-side end portion 51B side.

In the present exemplary embodiment, in the developer movement direction, the partition 301 is positioned closer to the downstream-side end portion 51B side than the central portion 51C of the opening 514B is. The partition 301 is disposed in a state of being closer to the downstream-side end portion 51B side than the central portion 51C of the opening 514B is.

In the configuration example shown in FIG. 19, developer density is likely to be uneven in the vertical flow path 514 through which both a developer and a gas pass.

Specifically, the developer density is high in the upstream-side space 302. Meanwhile, in the downstream-side space 303, the developer density is low in comparison with the upstream-side space 302.

As a result, a gas that flows from the developing device 14 to the supply device 70 and that moves upward through the vertical flow path 514 moves easily.

In FIG. 19, a perpendicular plane 320 that extends along the perpendicular direction and that extends through the partition 301 is shown.

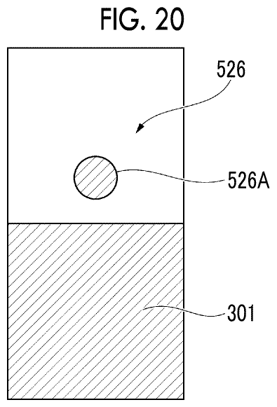

FIG. 20 shows the state of the central transport member 526 and the partition 301 in the perpendicular plane 320 shown in FIG. 19.

In the present exemplary embodiment, as shown in FIG. 20, no protruding portion 526B is provided on the perpendicular plane 320.

As shown in FIG. 19, the central transport member 526 is provided with the protruding portions 526B. As shown in FIG. 20, no protruding portion 326B is provided on the perpendicular plane 320.

Accordingly, in the present exemplary embodiment, the central transport member 526 and the partition 301 do not interfere with each other.

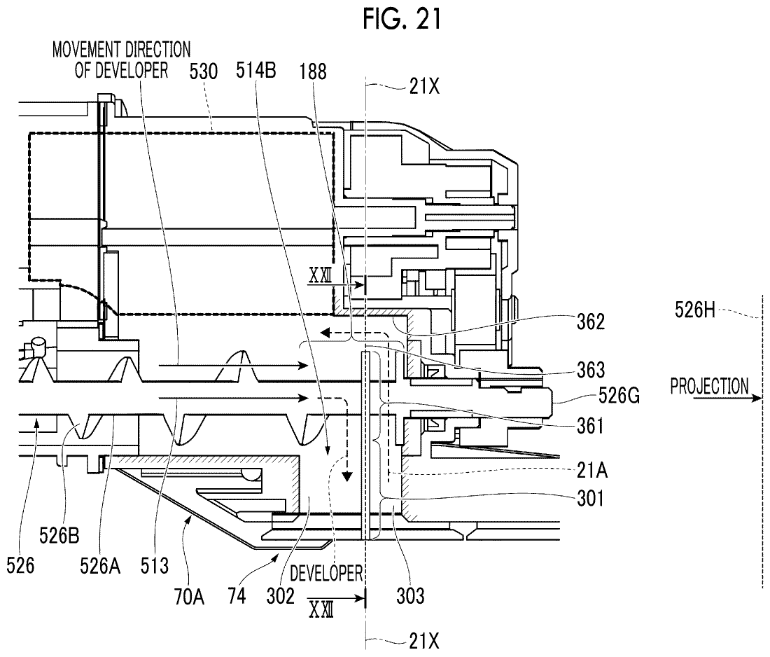

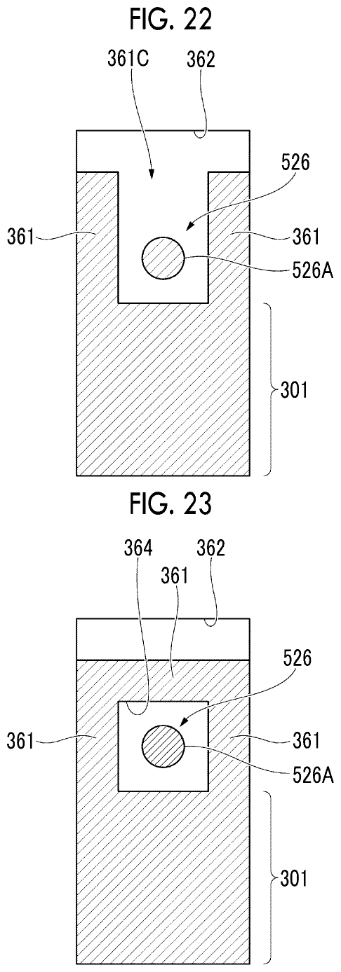

FIGS. 21 and 22 are views showing another configuration example of the supply device 70. FIG. 22 shows the state of a cross section taken along line XXII-XXII of FIG. 21.

In this configuration example, as shown in FIG. 21, guide portions 361 that cause a developer moving through the lateral flow path 513 to move downward are provided.

The guide portions 361 are composed of plate-shaped members. The guide portions 361 are provided at the faced position 188 that the opening 514B faces.

Furthermore, the guide portions 361 are provided on lines extending from the partition 301. The guide portions 361 are provided to extend in a direction intersecting the developer movement direction.

In addition, the guide portions 361 are provided in a state of being along the vertical direction. More specifically, the guide portions 361 are provided in a state of being along the perpendicular direction.

In the configuration example shown in FIG. 21, one component constitutes the partition 301 and the guide portions 361. In the present exemplary embodiment, the partition 301 and the guide portions 361 are integrated with each other.

Note that a component that functions as the partition 301 and components that function as the guide portions 361 may be individually provided instead of one component functioning as both the partition 301 and the guide portions 361.

In a case where the component functioning as the partition 301 and the components functioning as the guide portions 361 are individually provided, the positions of the components may be offset from each other in the developer movement direction.

In a case where the positions of the components are offset from each other, the guide portions 361 may be disposed upstream of the partition 301 in the developer movement direction, for example.

Here, a case where both the central transport member 526 and the guide portions 361 are projected in the developer movement direction will be considered. In other words, a case where both the central transport member 526 and the guide portions 361 are projected in the axial direction of the central transport member 526 will be considered.

More specifically, a case where both the central transport member 526 and the guide portions 361 are projected onto a virtual plane 526H orthogonal to the axial direction of the central transport member 526 will be considered.

In the present exemplary embodiment, in a case where such projection is performed, the central transport member 526 and the guide portions 361 overlap each other on the virtual plane 526H.

In the present exemplary embodiment, the guide portions 361 are provided such that the central transport member 526 and the guide portions 361 overlap each other on the virtual plane 526H.

Since the guide portions 361 are provided, it is difficult for a developer that has moved through the lateral flow path 513 to move toward the downstream-side space 303 side.

In a case where the developer that has moved through the lateral flow path 513 reaches a position where the guide portions 361 are installed, movement of the developer is restricted by the guide portions 361. Accordingly, the developer moves downward without moving toward the downstream-side space 303 side and moves toward the upstream-side space 302.

A surface 362 facing a lower side is provided above the guide portions 361. The surface 362 facing the lower side is a portion of surfaces of the body portion 70A of the supply device 70.

In the present exemplary embodiment, a gap 363 is provided between the guide portions 361 and the surface 362 facing the lower side.

Accordingly, a gas flowing upward through the downstream-side space 303 moves more easily. The gas flowing upward through the downstream-side space 303 moves toward the gas flow path 530 through the gap 363, as represented by an arrow 21A.

As described above, the central transport member 526 includes the rod-shaped rotary shaft 526A and the protruding portions 526B. The rotary shaft 526A is provided along the lateral flow path 513.

The protruding portions 526B are supported by the rotary shaft 526A. The protruding portions 526B push out a developer toward the opening 514B side. The protruding portions 526B can be regarded as push-out portions that push out the developer.

A broken line represented by a reference numeral “21X” in FIG. 21 represents an intersection plane that is a plane intersecting a direction in which the rotary shaft 526A extends and that extends through the guide portions 361. More specifically, the broken line represented by the reference numeral “21X” represents an orthogonal plane that is orthogonal to the direction in which the rotary shaft 526A extends and that extends through the guide portions 361.

As shown in FIG. 22, the protruding portions 526B functioning as push-out portions are not provided on the intersection plane represented by the reference numeral “21X”. Accordingly, interference between the central transport member 526 and the guide portions 361 is avoided. In addition, in a case where the protruding portions 526B are not provided, the guide portions 361 may be installed closer to the rotary shaft 526A.

The guide portions 361 are provided with a notch 361C for passage of the rotary shaft 526A provided at the central transport member 526.

In FIG. 22, the guide portions 361 are provided on both sides with respect to the rotary shaft 526A.

The guide portions 361 are provided on both sides with respect to the rotary shaft 526A in a direction orthogonal to an axial direction of the rotary shaft 526A and in a horizontal direction.

Note that the guide portions 361 may be provided on only one side with respect to the rotary shaft 526A instead of being provided on both sides with respect to the rotary shaft 526A.

FIG. 23 is a view showing another configuration example of the guide portions 361.

In addition, as shown in FIG. 23, a through-hole 364 may be provided and the rotary shaft 526A of the central transport member 526 may be disposed through the through-hole 364. In the configuration example shown in FIG. 23, the guide portion 361 is also positioned above the rotary shaft 526A.

In a configuration in which the through-hole 364 is provided, no protruding portion 526B is provided closer to the right side in the drawing than the broken line represented by the reference numeral “21X” shown in FIG. 21 is.

In addition, in a case where the rotary shaft 526A of the central transport member 526 is to be inserted into the through-hole 364, the rotary shaft 526A is inserted into the through-hole 364 with a right end portion 526G (refer to FIG. 21) of the rotary shaft 526A in the drawing as a leading end.

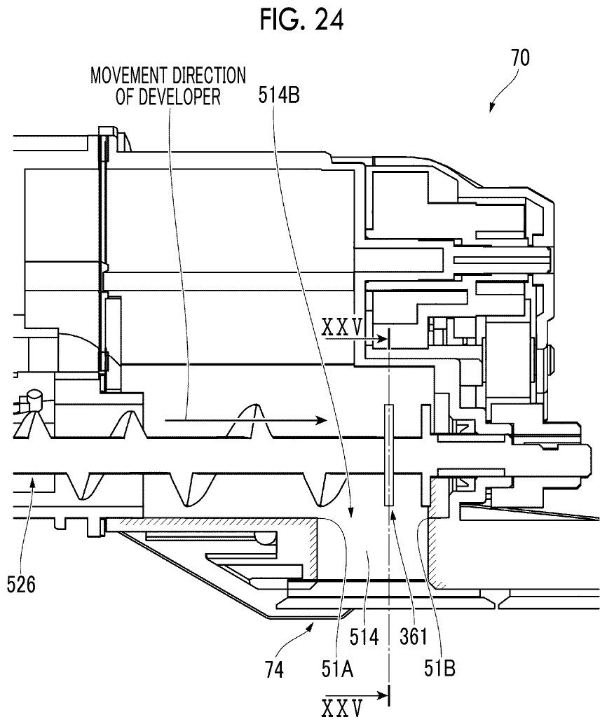

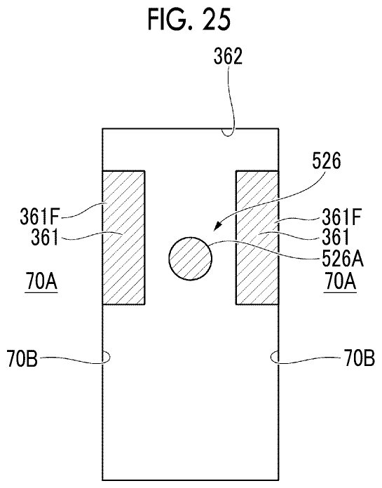

FIGS. 24 and 25 are views showing another configuration example of the supply device 70. FIG. 25 shows the state of a cross section of the supply device 70 taken along line XXV-XXV in FIG. 24.

In the configuration example shown in FIGS. 19 to 23, the partition 301 is provided. Installation of the partition 301 is not necessary. As shown in FIGS. 24 and 25, a configuration in which only the guide portions 361 are provided may also be adopted.

In this configuration example, as shown in FIG. 25, the guide portions 361 are provided on both sides with respect to the rotary shaft 526A. In this configuration example, a side portion 361F of each of the guide portions 361 is fixed to the inner wall 70B of the body portion 70A of the supply device 70.

Note that as described above, the guide portions 361 do not need to be provided on both sides with respect to the rotary shaft 526A. The guide portions 361 may be provided on only one side with respect to the rotary shaft 526A.

In this configuration example as well, a developer transported by the central transport member 526 shown in FIG. 24 is caused to move downward by the guide portions 361.

As in the above description, in this configuration example as well, movement of the developer transported by the central transport member 526 is restricted by the guide portions 361. Then, the developer moves downward and reaches the opening 514B shown in FIG. 24.

The guide portions 361 are positioned downstream of the upstream-side end portion 51A of the opening 514B in the developer movement direction. In addition, the guide portions 361 are positioned upstream of the downstream-side end portion 51B of the opening 514B in the developer movement direction.

Also in the case of such a configuration shown in FIGS. 24 and 25, developer density is likely to be uneven in the vertical flow path 514. Also in this configuration example, a gas moving upward through the vertical flow path 514 moves easily.

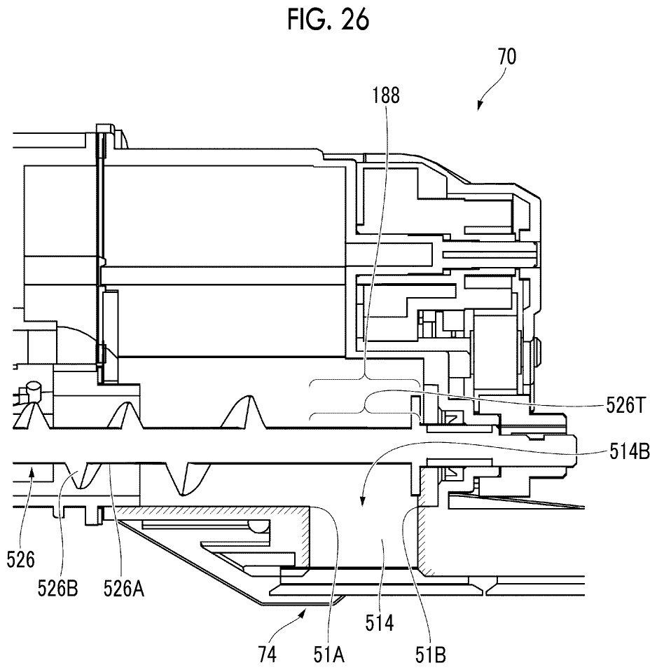

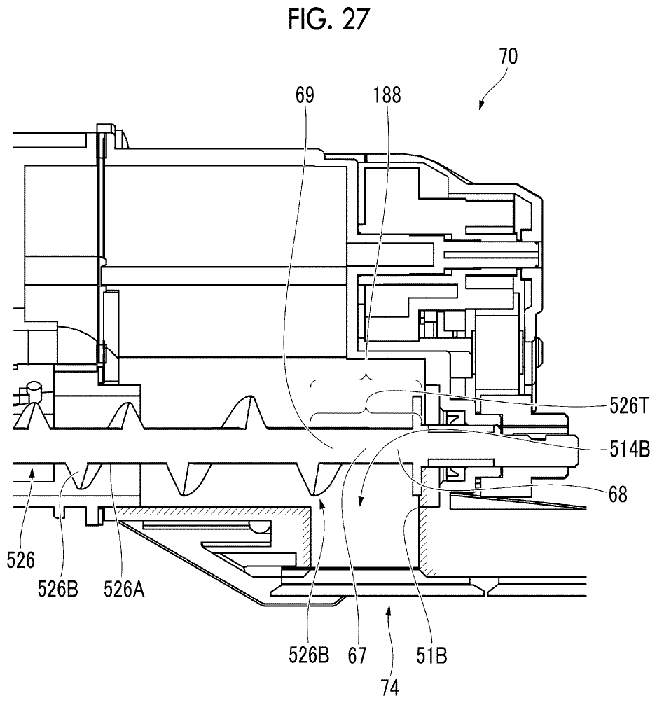

FIGS. 26 and 27 are views showing another configuration example of the supply device 70.

In the configuration example shown in FIG. 26, the protruding portions 526B functioning as push-out portions are not provided on a facing portion 526T.

The “facing portion 526T” refers to a portion of the central transport member 526 that is positioned at the faced position 188 that the opening 514B faces.

In this configuration example, the protruding portions 526B are not provided on the facing portion 526T. In this configuration example, the protruding portions 526B are not provided over the entire facing portion 526T.

Also in this configuration example, it is difficult for a developer to reach the downstream-side end portion 51B side of the opening 514B. Accordingly, in this case as well, a gas moving upward through the vertical flow path 514 moves easily.

For example, it is preferable that a configuration in which at least a portion of the facing portion 526T is not provided with the protruding portions 526B is adopted.

As described above, the protruding portions 526B may not be provided over the entire facing portion 526T.

In addition, a configuration in which a portion of the facing portion 526T is not provided with the protruding portions 526B may also be adopted. Specifically, for example, as shown in FIG. 27, a configuration in which the protruding portions 526B are not provided on a downstream-side portion 68 of the facing portion 526T may also be adopted.

In the configuration example shown in FIG. 27, the protruding portion 526B is provided on an upstream-side portion 69 of the facing portion 526T.

The “upstream-side portion 69” refers to a portion of the facing portion 526T that is positioned upstream of, in the developer movement direction, a central portion 67 of the facing portion 526T in the developer movement direction.

In addition, the “downstream-side portion 68” refers to a portion of the facing portion 526T that is positioned downstream of, in the developer movement direction, the central portion 67.

Also in the case of this configuration example shown in FIG. 27, it is difficult for a developer to reach the downstream-side end portion 51B side of the opening 514B. It is difficult for the developer to reach the downstream-side end portion 51B side of the opening 514B in comparison with a case where the protruding portions 526B are provided over the entire facing portion 526T.

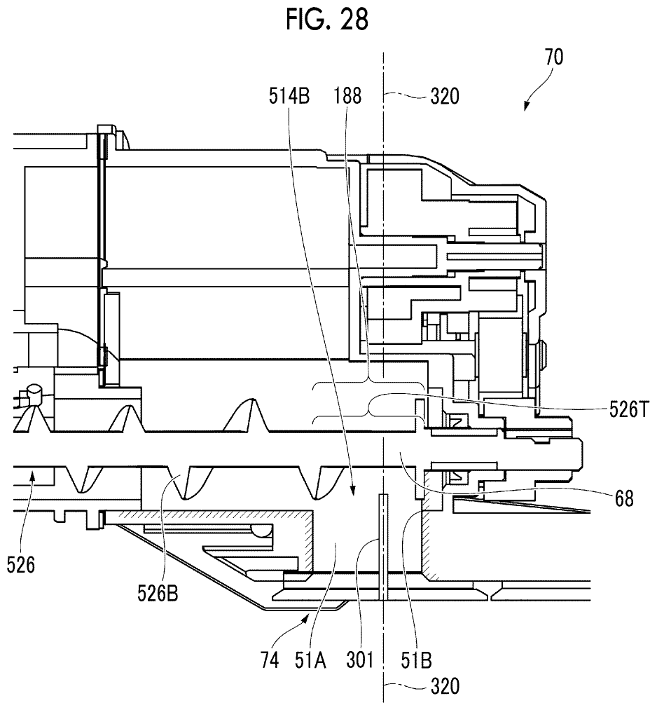

FIG. 28 is a view showing another configuration example of the supply device 70.

In this configuration example, a portion of the facing portion 526T is not provided with the protruding portions 526B. Specifically, the protruding portions 526B are not provided on the downstream-side portion 68 of the facing portion 526T.

Furthermore, in this configuration example, the partition 301 is provided in the vertical flow path 514.

As in the configuration example shown in FIG. 28, the partition 301 may be provided in the vertical flow path 514 while a portion of the facing portion 526T is not provided with the protruding portions 526B.

Here, the perpendicular plane 320 extending through the partition 301 will be assumed. In this configuration example shown in FIG. 28, the perpendicular plane 320 intersects the facing portion 526T.

In this configuration example, a portion of the facing portion 526T that is positioned downstream of a position, at which the perpendicular plane 320 intersects the facing portion 526T, in the developer movement direction is not provided with the protruding portions 526B.

Also in this configuration example, it is difficult for a developer to reach the downstream-side end portion 51B side of the opening 514B as in the above description.

Note that, in addition, the protruding portions 526B may not be provided over the entire facing portion 526T in this configuration example shown in FIG. 28. In this case, is more difficult for a developer to reach the downstream-side end portion 51B side.

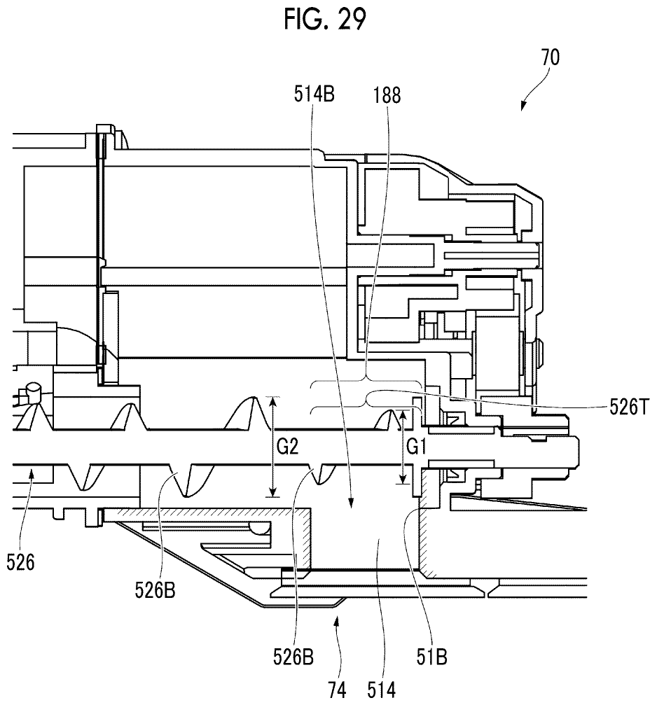

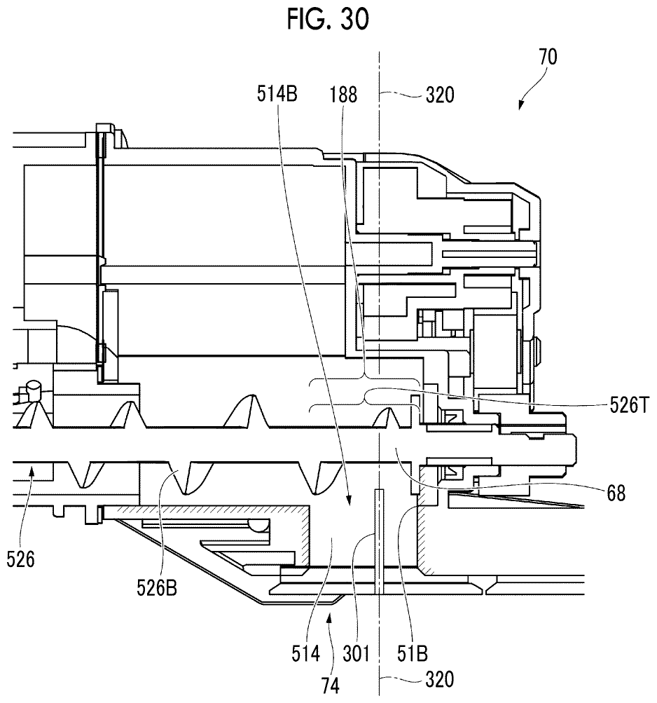

FIGS. 29 and 30 are views showing another configuration example of the supply device 70.

In the configuration example shown in FIG. 29, an outer diameter G1 of the protruding portion 526B provided on the facing portion 526T is smaller than an outer diameter G2 of the protruding portion 526B positioned at a position separated from the facing portion 526T.

Here, the “position separated from the facing portion 526T” refers to a position positioned upstream of the facing portion 526T in the developer movement direction.

In this configuration example, it is difficult for a developer to reach the downstream-side end portion 51B side of the opening 514B in comparison with a case where the outer diameter G1 of the protruding portion 526B provided on the facing portion 526T is not small.

Note that the outer diameters of the protruding portions 526B do not need to be small over the entire facing portion 526T.

As shown in FIG. 30, for example, the outer diameters of the protruding portions 526B may be small at a portion of the facing portion 526T that is positioned on a side close to the downstream-side end portion 51B.

In other words, the outer diameters of the protruding portions 526B may be small at the downstream-side portion 68 of the facing portion 526T.

In addition, as shown in FIG. 30, the partition 301 may be provided in the vertical flow path 514 with the outer diameters of the protruding portions 526B being small.

In this configuration example shown in FIG. 30, the outer diameters of the protruding portions 526B are small at a portion of the facing portion 526T that is positioned downstream of the position, at which the perpendicular plane 320 intersects the facing portion 526T, in the developer movement direction.

In addition, the outer diameters of the protruding portions 526B may also be small at a portion of the facing portion 526T that is positioned upstream of the position, at which the perpendicular plane 320 intersects the facing portion 526T, in the developer movement direction.

In addition, the outer diameters of the protruding portions 526B may be small over the entire facing portion 526T with the partition 301 being provided in the vertical flow path 514.

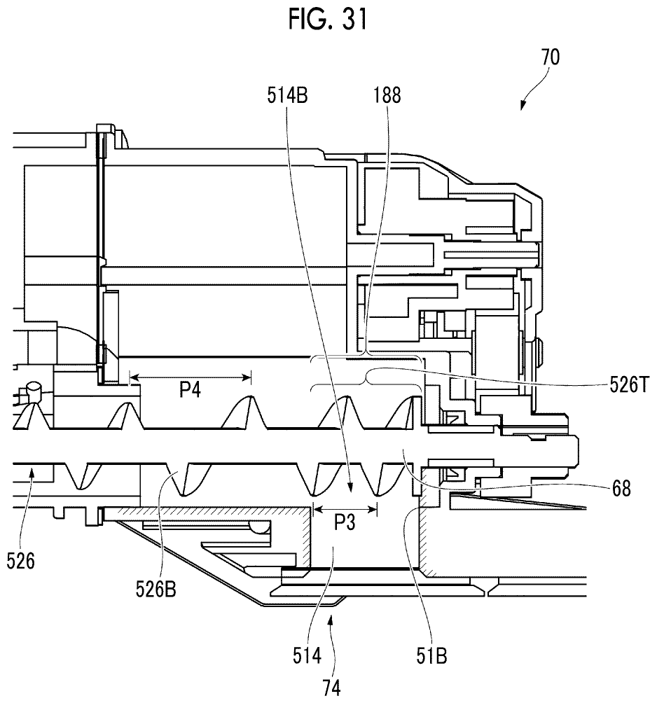

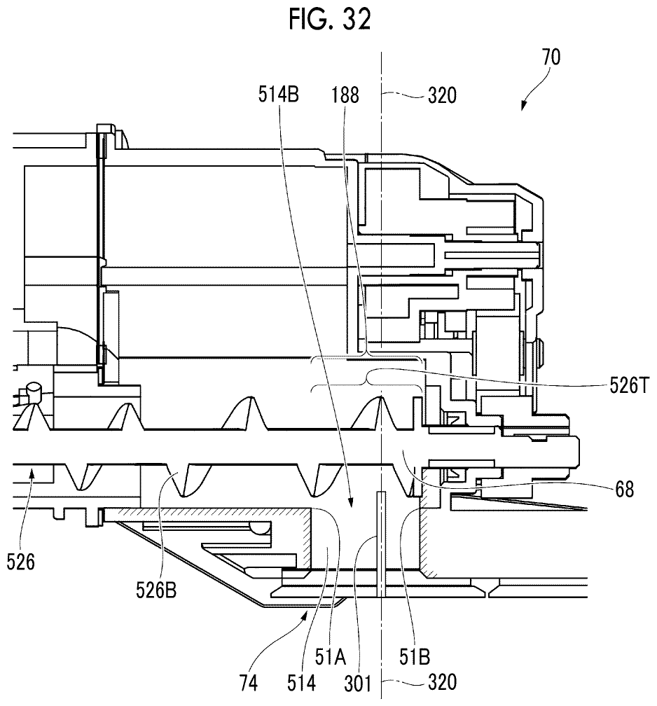

FIGS. 31 and 32 are views showing another configuration example of the supply device 70.

In the configuration example shown in FIG. 31, an arrangement pitch P3 of the protruding portions 526B provided on the facing portion 526T is smaller than an arrangement pitch P4 of the protruding portions 526B positioned at portions separated from the facing portion 526T.

In this case as well, it is difficult for a developer to reach the downstream-side end portion 51B side of the opening 514B in comparison with a configuration in which the arrangement pitch is not small.

Note that the arrangement pitch of the protruding portions 526B does not need to be small over the entire facing portion 526T.

As shown in FIG. 32, for example, the arrangement pitch of the protruding portions 526B may be small only at a portion of the facing portion 526T that is positioned on the side close to the downstream-side end portion 51B.

In other words, the arrangement pitch of the protruding portions 526B may be small only at the downstream-side portion 68 of the facing portion 526T.

In addition, as shown in FIG. 32, the partition 301 may be provided in the vertical flow path 514 with the arrangement pitch of the protruding portions 526B being small.

In this configuration example shown in FIG. 32, the arrangement pitch of the protruding portions 526B is small at a portion of the facing portion 526T that is positioned on a side closer to the downstream-side end portion 51B than the position, at which the perpendicular plane 320 intersects the facing portion 526T, is.

In other words, in this configuration example shown in FIG. 32, the arrangement pitch of the protruding portions 526B is small at a portion of the facing portion 526T that is positioned downstream of the position, at which the perpendicular plane 320 intersects the facing portion 526T, in the developer movement direction.

Note that in addition, the arrangement pitch may also be small at a portion of the facing portion 526T that is positioned on a side closer to the upstream-side end portion 51A than the position, at which the perpendicular plane 320 intersects the facing portion 526T, is.

In addition, the arrangement pitch of the protruding portions 526B may be small over the entire facing portion 526T with the partition 301 being provided in the vertical flow path 514.

### Others

In the configuration example shown in FIGS. 26 to 32 as well, the guide portions 361 described above may be provided at the faced position 188 that the opening 514B faces.

Furthermore, the configuration example shown in FIGS. 19 to 32 may be applied to the second exemplary embodiment shown in FIGS. 16 to 18.

In the second exemplary embodiment as well, as with the first exemplary embodiment, the vertical flow path 514 and the lower-side flow path 582 corresponding to the intersection direction flow path are provided as shown in FIG. 16. In addition, in the second exemplary embodiment as well, as with the first exemplary embodiment, the lower-side transport member 632 that transports a developer toward the vertical flow path 514 is provided.

Even in a case where the configuration example shown in FIGS. 19 to 32 is applied to the second exemplary embodiment, a gas flowing upward flows easily in the vertical flow path 514.

### Supplementary Note

(((1)))

An image forming apparatus comprising:
an image holding body;
a developing device that causes a developer to adhere to the image holding body; and
a supply device that supplies the developer to the developing device and that includes an intersection direction flow path, which is a flow path that extends in an intersection direction and through which the developer passes, and a downward flow path, which is a flow path through which the developer moving through the intersection direction flow path passes and that extends downward so that the developer moving downward passes through the downward flow path, the intersection direction being a direction intersecting a perpendicular direction,
wherein a partition that partitions a space in the downward flow path and that partitions the space into a space positioned on an upstream side in a movement direction of the developer in the intersection direction flow path and a space positioned on a downstream side in the movement direction is provided in the downward flow path.

(((2)))

The image forming apparatus according to (((1))),
wherein an upper end portion of the downward flow path is provided with an opening that faces an upper side, and
an upper end portion of the partition is positioned above the opening.

(((3)))

The image forming apparatus according to (((2))),
wherein a transport member that is disposed along the intersection direction and that transports the developer in the intersection direction flow path toward a side on which the opening is positioned is further provided, and
the upper end portion of the partition is positioned above a lower end portion of the transport member.

(((4)))

The image forming apparatus according to any one of (((1))) to (((3))),
wherein an upper end portion of the downward flow path is provided with an opening that faces an upper side,
the opening includes an upstream-side end portion, which is an end portion that is positioned on the upstream side in the movement direction of the developer moving in the intersection direction flow path, and a downstream-side end portion, which is an end portion that is positioned on a side opposite to a side on which the upstream-side end portion is positioned with a central portion of the opening in the movement direction interposed therebetween and that is positioned on the downstream side in the movement direction, and
the partition is provided closer to a downstream-side end portion side than the central portion is in the movement direction of the developer moving in the intersection direction flow path.

(((5)))

The image forming apparatus according to (((1))),
wherein an upper end portion of the downward flow path is provided with an opening that faces an upper side and that the developer moving through the intersection direction flow path enters, and
a guide portion that causes the developer moving through the intersection direction flow path to move downward is provided at a faced position that the opening faces.

(((6)))

The image forming apparatus according to (((5))),
wherein the guide portion is provided on a line extending from the partition.

(((7)))

The image forming apparatus according to (((5))) or (((6))),
wherein one component constitutes the partition and the guide portion.

(((8)))

The image forming apparatus according to any one of (((5))) to (((7))),
wherein a surface facing a lower side is provided above the guide portion, and
a gap is provided between the guide portion and the surface facing the lower side.

(((9)))

The image forming apparatus according to any one of (((5))) to (((8))),
wherein the guide portion is provided to extend, along a vertical direction, in a direction intersecting the movement direction of the developer in the intersection direction flow path.

(((10)))

The image forming apparatus according to any one of (((5))) to (((9))),
wherein a transport member that transports the developer in the intersection direction flow path toward a side on which the opening is positioned is further provided, and
the guide portion is provided such that the transport member and the guide portion overlap each other in a case where both the transport member and the guide portion are projected to the downstream side in the movement direction of the developer in the intersection direction flow path.

(((11)))

The image forming apparatus according to (((10))),
wherein the transport member includes a rotary shaft that is provided along the intersection direction flow path and a push-out portion that is supported by the rotary shaft and that pushes out the developer toward an opening side, and
the push-out portion is not provided on an intersection plane that is a plane intersecting a direction in which the rotary shaft extends and that extends through the guide portion.

(((12)))

The image forming apparatus according to (((10))),
wherein the transport member includes a rotary shaft that is provided along the intersection direction flow path and a push-out portion that is supported by the rotary shaft and that pushes out the developer toward an opening side, and
the guide portion is provided with a notch or a through-hole for passage of the rotary shaft.

(((13)))

An image forming apparatus comprising:
an image holding body;
a developing device that causes a developer to adhere to the image holding body; and
a supply device that supplies the developer to the developing device and that includes an intersection direction flow path, which is a flow path that extends in an intersection direction and through which the developer passes, and a downward flow path, which is a flow path through which the developer moving through the intersection direction flow path passes and that extends downward so that the developer moving downward passes through the downward flow path, the intersection direction being a direction intersecting a perpendicular direction,
wherein an upper end portion of the downward flow path is provided with an opening that faces an upper side and that the developer moving through the intersection direction flow path enters, and
a guide portion that causes the developer moving through the intersection direction flow path to move downward is provided at a faced position that the opening faces.

(((14)))

An image forming apparatus comprising:
an image holding body;
a developing device that causes a developer to adhere to the image holding body; and
a supply device that supplies the developer to the developing device and that includes a downward flow path that includes an opening facing an upper side, that extends downward from the opening, and through which the developer moving downward from the opening passes and a transport member that extends in a direction intersecting a perpendicular direction and that transports the developer toward a faced position that the opening faces from a position separated from the faced position,
wherein the transport member includes a rotary shaft that extends along a transport direction of the developer and push-out portions that are supported by the rotary shaft and that push out the developer toward an opening side, and
at least a portion of a facing portion, which is a portion of the transport member that is positioned at the faced position that the opening faces, is not provided with the push-out portions, outer diameters of the push-out portions provided at the facing portion are smaller than outer diameters of the push-out portions positioned at the position separated from the faced position, or an arrangement pitch of the push-out portions provided at the facing portion is smaller than an arrangement pitch of the push-out portions positioned at the position separated from the faced position.

(((15)))

The image forming apparatus according to (((14))),
wherein the entire facing portion is not provided with the push-out portions.

(((16)))

The image forming apparatus according to (((14))),
wherein the opening includes an upstream-side end portion, which is an end portion that is positioned on an upstream side in a developer transport direction, and a downstream-side end portion, which is an end portion positioned on a downstream side in the developer transport direction, the developer transport direction being the transport direction of the developer transported by the transport member,
a partition that partitions a space in the downward flow path into a space positioned on an upstream-side end portion side and a space positioned on a downstream-side end portion side is provided in the downward flow path,
a perpendicular plane intersects the facing portion on an assumption that the perpendicular plane extends along the perpendicular direction and extends through the partition, and
a portion of the facing portion that is positioned downstream of a position, at which the perpendicular plane intersects the facing portion, in the developer transport direction is not provided with the push-out portions.

(((17)))

The image forming apparatus according to (((14))),
wherein the opening includes an upstream-side end portion, which is an end portion that is positioned on an upstream side in a developer transport direction, and a downstream-side end portion, which is an end portion positioned on a downstream side in the developer transport direction, the developer transport direction being the transport direction of the developer transported by the transport member,
a partition that partitions a space in the downward flow path into a space positioned on an upstream-side end portion side and a space positioned on a downstream-side end portion side is provided in the downward flow path,
a perpendicular plane intersects the facing portion on an assumption that the perpendicular plane extends along the perpendicular direction and extends through the partition, and
outer diameters of the push-out portions provided at a portion of the facing portion that is positioned downstream of a position, at which the perpendicular plane intersects the facing portion, in the developer transport direction are smaller than the outer diameters of the push-out portions positioned at the position separated from the faced position.

(((18)))

The image forming apparatus according to (((14))),
wherein the opening includes an upstream-side end portion, which is an end portion that is positioned on an upstream side in a developer transport direction, and a downstream-side end portion, which is an end portion positioned on a downstream side in the developer transport direction, the developer transport direction being the transport direction of the developer transported by the transport member,
a partition that partitions a space in the downward flow path into a space positioned on an upstream-side end portion side and a space positioned on a downstream-side end portion side is provided in the downward flow path,
a perpendicular plane intersects the facing portion on an assumption that the perpendicular plane extends along the perpendicular direction and extends through the partition, and
an arrangement pitch of the push-out portions provided at a portion of the facing portion that is positioned downstream of a position, at which the perpendicular plane intersects the facing portion, in the developer transport direction is smaller than the arrangement pitch of the push-out portions positioned at the position separated from the faced position.

(((19)))

The image forming apparatus according to any one of (((14))) to (((18))),
wherein a guide portion that causes the developer transported by the transport member to move downward is provided at the faced position that the opening faces.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holding body;
a developing device that causes a developer to adhere to the image holding body; and
a supply device that supplies the developer to the developing device and that includes an intersection direction flow path, which is a flow path that extends in an intersection direction and through which the developer passes, and a downward flow path, which is a flow path through which the developer moving through the intersection direction flow path passes and that extends downward so that the developer moving downward passes through the downward flow path, the intersection direction being a direction intersecting a perpendicular direction,
wherein a partition that partitions a space in the downward flow path and that partitions the space into a space positioned on an upstream side in a movement direction of the developer in the intersection direction flow path and a space positioned on a downstream side in the movement direction is provided in the downward flow path.

2. The image forming apparatus according to claim 1,
wherein an upper end portion of the downward flow path is provided with an opening that faces an upper side, and
an upper end portion of the partition is positioned above the opening.

3. The image forming apparatus according to claim 2,
wherein a transport member that is disposed along the intersection direction and that transports the developer in the intersection direction flow path toward a side on which the opening is positioned is further provided, and
the upper end portion of the partition is positioned above a lower end portion of the transport member.

4. The image forming apparatus according to claim 1,
wherein an upper end portion of the downward flow path is provided with an opening that faces an upper side,
the opening includes an upstream-side end portion, which is an end portion that is positioned on the upstream side in the movement direction of the developer moving in the intersection direction flow path, and a downstream-side end portion, which is an end portion that is positioned on a side opposite to a side on which the upstream-side end portion is positioned with a central portion of the opening in the movement direction interposed therebetween and that is positioned on the downstream side in the movement direction, and
the partition is provided closer to a downstream-side end portion side than the central portion is in the movement direction of the developer moving in the intersection direction flow path.

5. The image forming apparatus according to claim 1,
wherein an upper end portion of the downward flow path is provided with an opening that faces an upper side and that the developer moving through the intersection direction flow path enters, and
a guide portion that causes the developer moving through the intersection direction flow path to move downward is provided at a faced position that the opening faces.

6. The image forming apparatus according to claim 5,
wherein the guide portion is provided on a line extending from the partition.

7. The image forming apparatus according to claim 5,
wherein one component constitutes the partition and the guide portion.

8. The image forming apparatus according to claim 5,
wherein a surface facing a lower side is provided above the guide portion, and
a gap is provided between the guide portion and the surface facing the lower side.

9. The image forming apparatus according to claim 5,
wherein the guide portion is provided to extend, along a vertical direction, in a direction intersecting the movement direction of the developer in the intersection direction flow path.

10. The image forming apparatus according to claim 5,
wherein a transport member that transports the developer in the intersection direction flow path toward a side on which the opening is positioned is further provided, and
the guide portion is provided such that the transport member and the guide portion overlap each other in a case where both the transport member and the guide portion are projected to the downstream side in the movement direction of the developer in the intersection direction flow path.

11. The image forming apparatus according to claim 10,
wherein the transport member includes a rotary shaft that is provided along the intersection direction flow path and a push-out portion that is supported by the rotary shaft and that pushes out the developer toward an opening side, and
the push-out portion is not provided on an intersection plane that is a plane intersecting a direction in which the rotary shaft extends and that extends through the guide portion.

12. The image forming apparatus according to claim 10,
wherein the transport member includes a rotary shaft that is provided along the intersection direction flow path and a push-out portion that is supported by the rotary shaft and that pushes out the developer toward an opening side, and
the guide portion is provided with a notch or a through-hole for passage of the rotary shaft.

13. An image forming apparatus comprising:
an image holding body;
a developing device that causes a developer to adhere to the image holding body; and
a supply device that supplies the developer to the developing device and that includes an intersection direction flow path, which is a flow path that extends in an intersection direction and through which the developer passes, and a downward flow path, which is a flow path through which the developer moving through the intersection direction flow path passes and that extends downward so that the developer moving downward passes through the downward flow path, the intersection direction being a direction intersecting a perpendicular direction,
wherein an upper end portion of the downward flow path is provided with an opening that faces an upper side and that the developer moving through the intersection direction flow path enters, and
a guide portion that causes the developer moving through the intersection direction flow path to move downward is provided at a faced position that the opening faces.

14. An image forming apparatus comprising:
an image holding body;
a developing device that causes a developer to adhere to the image holding body; and
a supply device that supplies the developer to the developing device and that includes a downward flow path that includes an opening facing an upper side, that extends downward from the opening, and through which the developer moving downward from the opening passes and a transport member that extends in a direction intersecting a perpendicular direction and that transports the developer toward a faced position that the opening faces from a position separated from the faced position,
wherein the transport member includes a rotary shaft that extends along a transport direction of the developer and push-out portions that are supported by the rotary shaft and that push out the developer toward an opening side, and
at least a portion of a facing portion, which is a portion of the transport member that is positioned at the faced position that the opening faces, is not provided with the push-out portions, outer diameters of the push-out portions provided at the facing portion are smaller than outer diameters of the push-out portions positioned at the position separated from the faced position, or an arrangement pitch of the push-out portions provided at the facing portion is smaller than an arrangement pitch of the push-out portions positioned at the position separated from the faced position.

15. The image forming apparatus according to claim 14,
wherein the entire facing portion is not provided with the push-out portions.

16. The image forming apparatus according to claim 14,
wherein the opening includes an upstream-side end portion, which is an end portion that is positioned on an upstream side in a developer transport direction, and a downstream-side end portion, which is an end portion positioned on a downstream side in the developer transport direction, the developer transport direction being the transport direction of the developer transported by the transport member,
a partition that partitions a space in the downward flow path into a space positioned on an upstream-side end portion side and a space positioned on a downstream-side end portion side is provided in the downward flow path,
a perpendicular plane intersects the facing portion on an assumption that the perpendicular plane extends along the perpendicular direction and extends through the partition, and
a portion of the facing portion that is positioned downstream of a position, at which the perpendicular plane intersects the facing portion, in the developer transport direction is not provided with the push-out portions.

17. The image forming apparatus according to claim 14,
wherein the opening includes an upstream-side end portion, which is an end portion that is positioned on an upstream side in a developer transport direction, and a downstream-side end portion, which is an end portion positioned on a downstream side in the developer transport direction, the developer transport direction being the transport direction of the developer transported by the transport member,
a partition that partitions a space in the downward flow path into a space positioned on an upstream-side end portion side and a space positioned on a downstream-side end portion side is provided in the downward flow path,
a perpendicular plane intersects the facing portion on an assumption that the perpendicular plane extends along the perpendicular direction and extends through the partition, and
outer diameters of the push-out portions provided at a portion of the facing portion that is positioned downstream of a position, at which the perpendicular plane intersects the facing portion, in the developer transport direction are smaller than the outer diameters of the push-out portions positioned at the position separated from the faced position.

18. The image forming apparatus according to claim 14,
wherein the opening includes an upstream-side end portion, which is an end portion that is positioned on an upstream side in a developer transport direction, and a downstream-side end portion, which is an end portion positioned on a downstream side in the developer transport direction, the developer transport direction being the transport direction of the developer transported by the transport member,
a partition that partitions a space in the downward flow path into a space positioned on an upstream-side end portion side and a space positioned on a downstream-side end portion side is provided in the downward flow path,
a perpendicular plane intersects the facing portion on an assumption that the perpendicular plane extends along the perpendicular direction and extends through the partition, and
an arrangement pitch of the push-out portions provided at a portion of the facing portion that is positioned downstream of a position, at which the perpendicular plane intersects the facing portion, in the developer transport direction is smaller than the arrangement pitch of the push-out portions positioned at the position separated from the faced position.

19. The image forming apparatus according to claim 14,
wherein a guide portion that causes the developer transported by the transport member to move downward is provided at the faced position that the opening faces.
